(19) United States
(12) Patent Application Publication
(10) Pub. No.: US 2016/0353498 A1
(43) Pub. Date: Dec. 1, 2016

(54) COMMUNICATION CONTROL METHOD, POSITION MANAGEMENT DEVICE, BASE STATION DEVICE, TERMINAL DEVICE, AND COMMUNICATION SYSTEM

(71) Applicant: SHARP KABUSHIKI KAISHA, Osaka-shi (JP)

(72) Inventors: MASAYUKI ENOMOTO, OSAKA (JP); MASAFUMI ARAMOTO, OSAKA (JP)

(73) Assignee: SHARP KABUSHIKI KAISHA, SAKAI CITY, OSAKA (JP)

(21) Appl. No.: 15/110,276

(22) PCT Filed: Jan. 9, 2015
(86) PCT No.: PCT/JP2015/050511

§ 371 Date: Jul. 7, 2016

(30) Foreign Application Priority Data
Jan. 10, 2014 (JP) 2014002849

(51) Int. Cl. H04W 76/02; H04W 60/04; H04W 4/02

(52) U.S. Cl. CPC H04W 76/023; H04W 4/023; H04W 60/04

(57) ABSTRACT

There are provided communication control procedures for a terminal device, a base station device, a position management device, a subscriber management device, and a server apparatus, respectively, each of which performs a tracking area update procedure when the terminal device establishes a direct communication path between the terminal device itself and a neighboring terminal using a proximity communication service, transitions to an idle state where a radio resource between the terminal device itself and the base station is released, and moves while continuing the proximity communication service, a mobile communication system, and the like.

In means or the position management device that detects that the terminal device performs a ProSe service, a tracking area update procedure is executed using detection means of a server apparatus that performs management of the Prose service.

### TECHNICAL FIELD

The present invention relates to a communication control method, a position management device, a base station device, a terminal device, and a communication system.

### BACKGROUND ART

In the 3rd Generation Partnership Project (3GPP) that is a standardization body for mobile communication systems, a job of developing a specification of an Evolved Packet System (EPS) that is disclosed in NPL 1 described below is proceeding as the next generation mobile communication system. As an access system that is connected to the EPS, a Wireless LAN (WLAN), as well as Long Term Evolution (LTE), has been under study.

Additionally, in 3GPP, as disclosed in NPL 2, a Proximity Service (ProSe) is considered in which a user terminal (User Equipment (UE)) is notified that a different user terminal is present nearby. Additionally, the ProSe aims for enabling the UE to establish a direct communication path without involving neighboring UE and a base station and to performing direct transmission and reception of data.

In the ProSe, because direct transmission and reception of data are performed between UEs, the transmission and reception of data can be performed without involving a mobile communication network such as a core network, or without involving an access network that is based on an access technology such as LTE. Thus, an off-load effect of avoiding traffic concentration is also expected.

For the ProSe, it is considered that two schemes are used for the direct communication path between UEs. One is a method of establishing the direct communication path between the UEs that uses an LTE access technology (which is referred to as LTE Direct), and the other is a method of establishing the direct communication path that uses a Wireless LAN access technology.

In LTE Direct, the UE uses a commercial frequency that is allocated to each mobile communications carrier in an LTE system, and the direct transmission and reception of data are performed between the UEs using an LTE communication scheme.

In WLAN Direct, the direct transmission and reception of data are performed between the UEs using a non-commercial frequency that is allocated in the WLAN.

Furthermore, in the ProSe, the need to search for a communication target UE and detect the presence of the communication target UE in the vicinity is cited as a service request condition for performing the transmission and reception of data using LTE Direct or WLAN Direct.

Additionally, in the ProSe, it is considered that any one of the UEs that perform direct communication establishes a direct communication path with different UE for connection and makes a connection to a base station that is arranged in an access network in the related art.

The UE that makes a connection to the base station makes a connection to the core network through the base station and establishes the communication path. Additionally, it is considered that the direct communication path to the different UE and the communication path to the core network are relayed. The UE that, with the relay in such a ProSe, establishes the direct communication path and makes a connection to the core network for the establishment of the communication path, has a relay function of receiving transmission data of the UE that is connected with the direct communication path and of delivering the received transmission data to the core network. Additionally, the UE has a relay function of receiving data that is delivered from the communication path that is connected to the core network and of transmitting the received data to the UE that is connected with the direct communication path through the direct communication path.

In this manner, an object in the ProSe is to provide a service in which a certain UE is notified of the presence of neighboring UE, and a service in which communication is provided using a direct communication path between UEs, and to provide a relay function that is performed by UE.

### CITATION LIST

### Non Patent Literature

NPL 1: 3GPP TS23.401 Technical Specification Group Services and System Aspects, General Packet Radio Service (GPRS) enhancements for Evolved Universal Terrestrial Radio Access Network (E-UTRAN) access
NPL 2: 3GPP TR22.803 Technical Specification Group Services and System Aspects, Feasibility study for Proximity Services (ProSe)

### SUMMARY OF INVENTION

### Technical Problem

However, at present, specific means for realizing a method of establishing the direct communication path in the ProSe and a method of position management that accompanies movement of the UE which establishes the direct communication path are not determined.

It is desirable that the establishment of the direct communication path for the UE is authenticated and approved by a position management device within a core network and a ProSe Server that manages the ProSe service.

Accordingly, there needs to be an authentication and approval procedure in which the UE not only establishes the direct communication path between the UE itself and neighboring UE, but also establishes the connectivity to the core network through the base station device.

On the other hand, in a case where the UE continues to retain the connectivity to the core network, because a radio resource between the UE and the base station, which is limited and thus is desirably efficiently used, continues to be occupied, it is desirable that the UE transitions to an idle mode known in the related art, thereby releasing the radio resource.

However, means for notifying a location in a case where the UE that performs communication using the direct communication path transitions to the idle mode and moves are not realized. Additionally, means for enabling the same ProSe Server to continue the service, following the movement are not definite.

An object of the present invention, which is made in view of the situations described above, is to provide processing operations by a terminal device, a base station, a position management device, and a subscriber management device, respectively, and a mobile communication system, each of which provides means for establishing a direct communication path between the terminal device and a neighboring terminal and enabling the terminal device to move while continuing a ProSe service.

### Solution to Problem

In order to deal with the problems described above, according to an aspect of the present invention, there is provided a communication control method for use in a position management device in a tracking area update procedure for updating a tracking area of a terminal device that transitions to an idle state where a radio resource is released, the method including: a step of receiving a tracking area update request that is transmitted by the terminal device and that is transferred by a base station device; a step of resolving an existing position management device with which the terminal device registers a tracking area, based on the tracking area update request; a step of transmitting a context request to the existing position management device; a step of receiving a context response that is a response to the context request and that is transmitted by the existing position management device; a step of acquiring information for identifying a ProSe Server, which is included in the context response; and a step of storing the information for identifying the ProSe Server and the terminal device in a state of being associated with each other.

Additionally, in the communication control method for use in a position management device in a tracking area update procedure for updating a tracking area of a terminal device that transitions to an idle state where a radio resource is released, according to the aspect of the present invention, identification information for requesting transmission of the information for identifying the ProSe Server is transmitted in a state of being included in the context request.

Additionally, in the communication control method for use in a position management device in a tracking area update procedure for updating a tracking area of a terminal device that transitions to an idle state where a radio resource is released, according to the aspect of the present invention, in a case where capability information indicating that the terminal device is able to perform communication using a direct communication path between the terminal device itself and a neighboring terminal is included in the tracking area update request, the identification information for requesting the transmission of the information for identifying the ProSe Server is transmitted in a state of being included in the context request, and in a case where the capability information is not included, the identification information for requesting the transmission of the information for identifying the ProSe Server is transmitted in a state of not being included in the context request.

According to another aspect of the present invention, there is provided a communication control method for use in a position management device in a tracking area update procedure for updating a tracking area of a terminal device that transitions to an idle state where a radio resource is released, the method including: a step of receiving a tracking area update request that is transmitted by the terminal device and that is transferred by a base station device; a step of transmitting a location update request that includes information for identifying the position management device and information for identifying the terminal device, to a subscriber information management device; a step of receiving a location update response that is a response to the location update request and that is transmitted by the subscriber information management device; a step of acquiring information for identifying a ProSe Server, which is included in the location update response; and a step of storing the information for identifying the ProSe Server and the terminal device in a state of being associated with each other.

Additionally, according to the aspect of the present invention, identification information for requesting transmission of the information for identifying the ProSe Server is transmitted in a state of being included in the location update request.

Additionally, in the communication control method for use in a position management device in a tracking area update procedure for updating a tracking area of a terminal device that transitions to an idle state where a radio resource is released, according to the aspect of the present invention, in a case where capability information indicating that the terminal device is able to perform communication using a direct communication path between the terminal device itself and a neighboring terminal is included in the tracking area update request, the identification information for requesting the transmission of the information for identifying the ProSe Server is transmitted in a state of being included in the location update request, and in a case where the capability information is not included, the identification information for requesting the transmission of the information for identifying the ProSe Server is transmitted in a state of not being included in the location update request.

Additionally, the communication control method for use in a position management device in a tracking area update procedure for updating a tracking area of a terminal device that transitions to an idle state where a radio resource is released, according to the aspect of the present invention, the method further including: a step of transmitting a context update request that includes the information for identifying the position management device, and the information for identifying the terminal device, to the ProSe Server, based on the acquisition of the information for identifying the ProSe Server; and a step of receiving a context update response that is a response to the context update request and that is transmitted by the ProSe Server 90.

According to still another aspect of the present invention, there is provided a communication control method for use in a terminal device in a tracking area update procedure for updating a tracking area of the terminal device that transitions to an idle state where a radio resource is released, the method including: a step of transmitting a tracking area update request that includes capability information indicating that the terminal device is able to perform communication using a direct communication path between the terminal device itself and a neighboring terminal, to a base station device; and a step of receiving a tracking area update acceptance that is a response to the tracking area update request and that is transmitted by a position management device.

According to still another aspect of the present invention, there is provided a communication control method for use in a base station device in a tracking area update procedure for updating a tracking area of a terminal device that transitions to an idle state where a radio resource is released, the method including: a step of receiving a tracking area update request that is transmitted by the terminal device; and a step of transmitting the tracking area update request that includes capability information indicating that the terminal device is able to perform communication using a direct communication path between the terminal device itself and a neighboring terminal, to a position management device, based on the reception of the tracking area update request.

According to still another aspect of the present invention, there is provided a position management device in a communication system that is constituted to include a terminal device that transitions to an idle state where a radio resource is released, a base station device that is constituted to be in an access network, a position management device that is constituted to be in a core network, and a subscriber management device, in which a tracking area update request that is transmitted by the terminal device and that is transferred by the base station device is received, in which an existing position management device with which the terminal device registers a tracking area is resolved based on the tracking area update request, in which a context request is transmitted to the existing position management device; in which a context response that is a response to the context request and that is transmitted by the existing position management device is received, in which information for identifying a ProSe Server, which is included in the context response, is acquired, and in which the information for identifying the ProSe Server and the terminal device are stored in a state of being associated with each other.

In the communication control method for use in a base station device in a tracking area update procedure for updating a tracking area of a terminal device that transitions to an idle state where a radio resource is released, according to the aspect of the present invention, identification information for requesting transmission of the information for identifying the ProSe Server is transmitted in a state of being included in the context request.

In the communication control method for use in a base station device in a tracking area update procedure for updating a tracking area of a terminal device that transitions to an idle state where a radio resource is released, according to the aspect of the present invention, in a case where capability information indicating that the terminal device is able to perform communication using a direct communication path between the terminal device itself and a neighboring terminal is included in the tracking area update request, the identification information for requesting the transmission of the information for identifying the ProSe Server is transmitted in a state of being included in the context request, and in a case where the capability information is not included, the identification information for requesting the transmission of the information for identifying the ProSe Server is transmitted in a state of not being included in the context request.

According to still another aspect of the present invention, there is provided a position management device in a communication system that is constituted to include a terminal device that transitions to an idle state where a radio resource is released, a base station device that is constituted to be in an access network, a position management device that is constituted to be in a core network, and a subscriber management device, in which a tracking area update request that is transmitted by the terminal device and that is transferred by the base station device is received, in which a location update request that includes information for identifying the position management device and information for identifying the terminal device is transmitted to a subscriber information management device, in which a location update response that is a response to the location update request and that is transmitted by the subscriber information management device is received, in which information for identifying a ProSe Server, which is included in the location update response, is acquired, and in which the information for identifying the ProSe Server and the terminal device are stored in a state of being associated with each other.

In the position management device in a communication system that is constituted to include a terminal device that transitions to an idle state where a radio resource is released, a base station device that is constituted to be in an access network, a position management device that is constituted to be in a core network, and a subscriber management device, according to the aspect of the present invention, identification information for requesting transmission of the information for identifying the ProSe Server is transmitted in a state of being included in the location update request.

In the position management device in a communication system that is constituted to include a terminal device that transitions to an idle state where a radio resource is released, a base station device that is constituted to be in an access network, a position management device that is constituted to be in a core network, and a subscriber management device, according to the aspect of the present invention, in a case where capability information indicating that the terminal device is able to perform communication using a direct communication path between the terminal device itself and a neighboring terminal is included in the tracking area update request, the identification information for requesting the transmission of the information for identifying the ProSe Server is transmitted in a state of being included in the location update request, and in a case where the capability information is not included, the identification information for requesting the transmission of the information for identifying the ProSe Server is transmitted in a state of not being included in the location update request.

In the position management device in a communication system that is constituted to include a terminal device that transitions to an idle state where a radio resource is released, a base station device that is constituted to be in an access network, a position management device that is constituted to be in a core network, and a subscriber management device, according to the aspect of the present invention, a context update request that includes the information for identifying the position management device, and the information for identifying the terminal device, is transmitted to the ProSe Server, based on the acquisition of the information for identifying the ProSe Server, and a context update response that is a response to the context update request and that is transmitted by the ProSe Server 90 is received.

According to still another aspect of the present invention, there is provided a terminal device that transitions to an idle state where a radio resource is released, in which a tracking area update request that includes capability information indicating that the terminal device is able to perform communication using a direct communication path between the terminal device itself and a neighboring terminal, is transmitted to a base station device, and in which a tracking area update acceptance that is a response to the tracking area update request and that is transmitted by a position management device is received.

According to still another aspect of the present invention, there is provided a base station device in a communication system that is constituted to include a terminal device that transitions to an idle state where a radio resource is released, a base station device that is constituted to be in an access network, a position management device that is constituted to be in a core network, and a subscriber management device, in which a tracking area update request that is transmitted by the terminal device is received, and in which the tracking area update request that includes capability information indicating that the terminal device is able to perform communication using a direct communication path between the terminal device itself and a neighboring terminal, is transmitted to the position management device, based on the reception of the tracking area update request.

According to still another aspect of the present invention, there is provided a communication system that is constituted to include a terminal device that transitions to an idle state where a radio resource is released, a base station device that is constituted to be in an access network, a position management device that is constituted to be in a core network, and a subscriber management device, in which the terminal device transmits a tracking area update request to the base station device, in which the base station device transmits the tracking area update request to the position management device, based on the reception of the tracking area update request, in which the position management device receives the tracking area update request that is transmitted by the terminal device and that is transferred by the base station device, in which an existing position management device with which the terminal device registers a tracking area is resolved based on the tracking area update request, in which a context request is transmitted to the existing position management device, in which a context response that is a response to the context request and that is transmitted by the existing position management device is received, in which information for identifying a ProSe Server, which is included in the context response, is acquired, in which the information for identifying the ProSe Server and the terminal device are stored in a state of being associated with each other, and in which a tracking area update acceptance is transmitted to the terminal device.

In the communication system that is constituted to include a terminal device that transitions to an idle state where a radio resource is released, a base station device that is constituted to be in an access network, a position management device that is constituted to be in a core network, and a subscriber management device, according to the aspect of the present invention, in a case where capability information indicating that the terminal device is able to perform communication using a direct communication path between the terminal device itself and a neighboring terminal is included in the tracking area update request, the position management device transmits the identification information for requesting the transmission of the information for identifying the ProSe Server, in a state of being included in the context request, and in a case where the capability information is not included, the position management device transmits the identification information for requesting the transmission of the information for identifying the ProSe Server, in a state of not being included in the context request.

In the communication system that is constituted to include a terminal device that transitions to an idle state where a radio resource is released, a base station device that is constituted to be in an access network, a position management device that is constituted to be in a core network, and a subscriber management device, according to the aspect of the present invention, a terminal device transmits a tracking area update request that includes capability information indicating that the terminal device is able to perform communication using a direct communication path between the terminal device itself and a neighboring terminal, to the base station device, and the terminal device receives a tracking area update acceptance that is a response to the tracking area update request and that is transmitted by the position management device.

### Advantageous Effects of Invention

According to the present invention, a terminal device can realize communication control that establishes a direction communication path between the terminal device itself and a neighboring terminal, continues a ProSe service, and updates a tracking area, while keeping modifications to the existing system to a minimum.

### BRIEF DESCRIPTION OF DRAWINGS

FIG. 1 is a diagram for describing an outline of a mobile communication system 1 according to a first embodiment.

FIG. 2 is a diagram for describing a functional constitution of UE according to an embodiment.

FIG. 3 is a diagram for describing a functional constitution of UE-R according to the embodiment.

FIG. 4 is a diagram for describing a functional constitution of an eNB according to the embodiment.

FIG. 5 is a diagram for describing a functional constitution of an MME according to the embodiment.

FIG. 6 is a diagram for describing a functional constitution of a ProSe Server according to the embodiment.

FIG. 7 is a diagram for describing a UE connection procedure according to the first embodiment.

FIG. 8 is a diagram for describing a modification embodiment of the UE connection procedure.

FIG. 9 is a diagram for describing a service registration procedure.

FIG. 10 is a diagram for describing a UE-R communication path establishment procedure.

FIG. 11 is a diagram for describing a UE communication path establishment procedure.

FIG. 12 is a diagram for describing a modification example of the UE communication path establishment procedure.

FIG. 13 is a diagram for describing a tracking update procedure according to the embodiment.

FIG. 14 is a diagram for describing a context update procedure that is executed on a ProSe Server, according to the embodiment.

FIG. 15 is a diagram for describing a modification example of the tracking area update procedure according to the embodiment.

### DESCRIPTION OF EMBODIMENTS

Best aspects of the present invention will be described below referring to the drawings. Moreover, as one embodiment, a mobile communication system according to the present embodiment of the present invention will be described in detail below referring to the drawings. Furthermore, LTE Direct is expressed as LTE(D). Here, LTE(D) indicates a direct communication path between UEs that are established using an LTE communication scheme.

### 1. First Embodiment

First, a first embodiment of the present invention is described referring to the drawings.

[1.1 Outline of a Mobile Communication System]

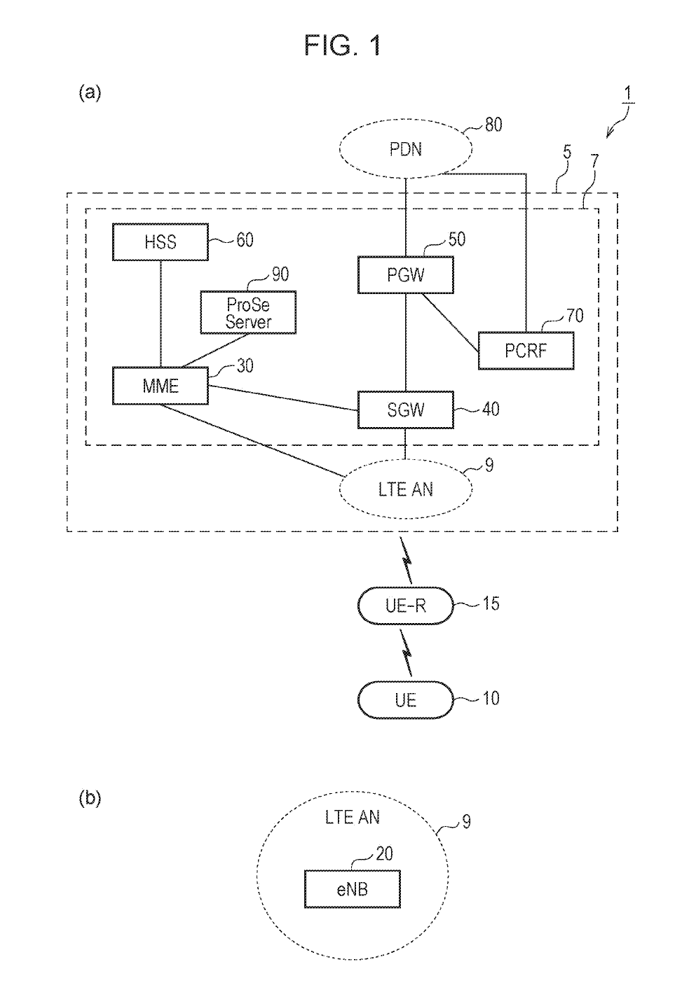

FIG. 1 is a diagram for describing an outline of a mobile communication system 1 according to the present invention. As illustrated in FIG. 1(a), the mobile communication system 1 is constituted by connecting UE (a terminal device) 10, a UE-R (a relay terminal device) 15, and a Packet Data Network (PDN) 80 through an IP mobile communication network 5. The UE 10 and the UE-R 15 are located near each other and can make connections to each other through LTE(D). The UE-R 15 makes a connection to the IP mobile communication network 5, and the IP mobile communication network 5 is connected to the PDN 80.

The IP mobile communication network 5, for example, may be a network that is constituted from a wireless access network and a core network that are managed by a mobile telecommunications carrier, and may be a broadband network that is managed by a fixed-line telecommunications carrier. Here, the broadband network may be an IP communication network that is connected using an Asymmetric Digital Subscriber Line (ADSL) or the like, provides high-speed communication through a digital line such as an optical fiber, and is managed by a telecommunications carrier. Additionally, without being limited to these, the broadband network may be a network that has wireless access using World-wide Interoperability for Microwave Access (WiMAX) or the like.

The UE 10 and the UE-R 15 are communication terminals that make connections using an access system, such as LTE or WLAN. Each of the UE 10 and the UE-R 15 is equipped with a 3GPP LTE communication interface, a WLAN communication interface, or the like for connection, and thus, is able to make connections to an IP access network.

As a specific example, the UE 10 and the UE-R 15 are portable telephone terminals or smartphones. The UE 10 and the UE-R 15 are tablet-type computers, personal computers, home appliances, or the like, each of which is equipped with a communication function.

The PDN 80 is a network that provides a network service of exchanging data in a packet, and for example, is the Internet, an IMS, or the like. Additionally, the PDN 80 may be a network that provides a group communication service such as a group call.

The UE-R 15 is a relay terminal device. Without being limited to the UE 10, the UE-R 15 can establish direct communication paths to multiple terminal devices using LTE(D), and can make a connection. Additionally, the relay terminal device is a terminal device that has a relay function. The UE-R 15 makes a connection to the IP mobile communication network, and thus establishes a communication path and establishes connectivity to the PDN 80.

The UE-R 15 has the relay function of relaying communication between the UE 10 and the PDN 80, and thus the UE 10 realizes transmission and reception of data to and from the PDN 80.

In this manner, the UE 10 and the UE-R 15 may be constituted in such a manner that they are different from each other depending on the presence or absence of the relay function.

The PDN 80 makes a connection to the IP access network using a wired line or the like. For example, the PDN 80 is set up using an Asymmetric Digital Subscriber Line (ADSL) or an optical fiber. However, without being limited to this, the PDN 80 may be a wireless access network, such as Long Term Evolution (LTE), a Wireless LAN (WLAN), or World-wide Interoperability for Microwave Access (WiMAX).

[1.1.1 Constitution Example of the IP Mobile Communication Network]

As illustrated in FIG. 1, the mobile communication system 1 is constituted from the UE 10, the UE-R 15, the IP mobile communication network 5, and the Packet Data Network (PDN) 80. Furthermore, multiple communication terminals other than the UE 10 may be connected to the UE-R 15. These communication terminals have the same constitution as the UE 10, and descriptions thereof are omitted for simplification of the drawing. Furthermore, in addition to the UE-R 15, a terminal device that has multiple relay functions can make a connection to the IP mobile communication network 5. Such a terminal device has the same constitution as the UE-R 15, and a description thereof is omitted for simplification of the drawing.

The IP mobile communication network 5 is constituted from the core network 7 and the wireless access network.

The core network 7 is constituted to include a Mobile Management Entity (MME) 30, a Serving Gateway (SGW) 40, a Packet Data Network Gateway (PGW) (an access control device) 50, a Home Subscriber Server (HSS) 60, a Policy and charging rules function (PCRF) 70, and a ProSe Server 90.

The wireless access network is connected to the core network 7. Additionally, the UE-R 15 can make a wireless connection to the wireless access network.

An LTE access network (an LTE AN 9) that can be connected in an LTE access system can be constituted in the wireless access network.

Moreover, because each device is constituted in the mobile communication system that uses an EPS, in the same manner as a device in the related art, a detailed description thereof is omitted, but a brief description thereof is provided as follows. The PGW 50 is connected to the PDN 80, the SGW 40, and the PCRF 70, and, as a gateway device to the PDN 80 and the core network 7, performs user data delivery.

The SGW 40 is connected to the PGW 50, the MME 30, and the LTE AN 9, and, as a gateway device to the core network 7 and the LTE AN 9, performs the user data delivery.

The MME 30 is connected to the SGW 40 and the LTE AN 9, and is a position management device that performs position management of the UE 10 through the LTE AN 9, and access control.

The HSS 60 is connected to the MME 30, and performs management of subscriber information.

The PCRF 70 is connected to the PGW 50 and performs QoS management of data delivery.

The ProSe Server 90 is connected to the MME 30, and is a server apparatus that manages establishment of the direct communication path between communication terminals. Moreover, the ProSe Server 90 and the MME 30 may be constituted to be integrated into a single device, and may be constituted as devices that are independent of each other. Furthermore, an example in which the ProSe Server 90 is constituted to be included in the core network 7 is described, but no limitation to this is imposed. The ProSe Server 90 may be constituted to be included in the PDN 80. Additionally, the ProSe Server 90 and a Group Communication Service Enablers Application Server (GCSE AS) that is constituted to be included in the PDN which provides group communication service may be constituted to be integrated into a single apparatus.

Furthermore, as illustrated in FIG. 1(b), a device (for example, a base station device or an access point device, or the like) to which the UE-R 15 makes a connection in practice is included in the wireless access network (LTE AN 9). For the device that is used for connection, various devices that are adapted for the wireless access network are considered, but according to the present embodiment, the LTE AN 9 is constituted to include an eNB 20. The eNB 20 is a wireless base station to which the UE-R 15 makes a connection in the LTE access system, and the LTE AN 9 may be constituted to include one or multiple wireless base stations.

Moreover, in the present specification, the UE-R 15 being connected to the wireless access network means the UE-R 15 being connected to the base station device that is included in the wireless access network, and data, signal, or the like that is transmitted and received also passes through the base station device or the access point.

For example, the UE-R 15 being connected to the LTE AN 9 means the UE-R 15 being connected through the eNB 20.

[1.2 Device Constitution]

Subsequently, a constitution of each device is described referring to the drawings.

[1.2.1 UE Constitution]

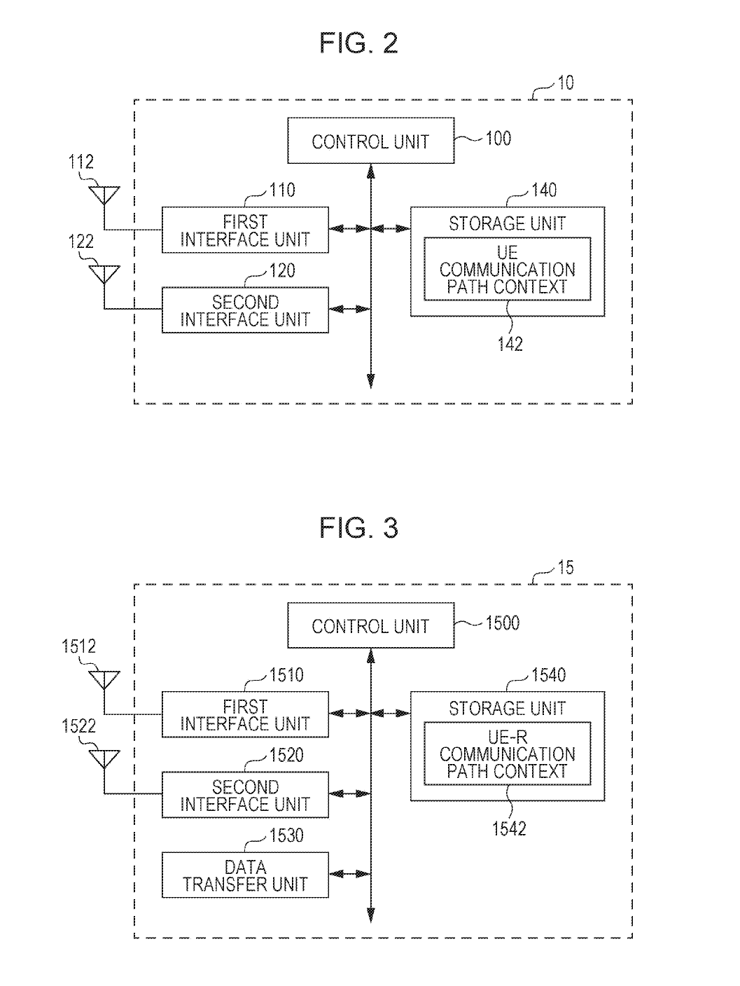

FIG. 2 illustrates a functional constitution of the UE 10 according to the present embodiment. In the UE 10, a control unit 100 is connected to a first interface unit 110, a second interface unit 120, and a storage unit 140 through a bus.

The control unit 100 is a functional unit for controlling the UE 10. The control unit 100 realizes various processing operations by reading and executing various pieces of information or various programs that are stored in the storage unit 140.

The first interface unit 110 is a functional unit that establishes the direct communication path between the UE 10 itself and a different communication terminal or the UE-R 15 using an LTE access scheme and performs data transmission and reception using wireless communication. An external antenna 112 is connected to the first interface unit 110.

The UE 10 can establish the direct communication path between the UE 10 itself and different UE or the UE-R through the first interface unit 110 without involving the LTE base station, and can perform communication.

The second interface unit 120 is a functional unit that makes a connection to the eNB 20 using the LTE access scheme, establishes the communication path to the PDN 80 through the core network 7, and performs the data transmission and reception using the wireless communication. An external antenna 122 is connected to the second interface unit 120.

The UE 10 can make a connection to the LTE AN 9 through the second interface unit 120, can establish the communication path between the UE 10 itself and the PDN 80 through the core network 7, and can perform the data transmission and reception, as well.

Moreover, the constitution in which the first interface unit 110 and the second interface unit 120 perform the communication through different antennas, respectively, is described referring to the drawing, but a configuration in which one antenna is shared may be possible.

The storage unit 140 is a functional unit in which programs or pieces of data that are indispensable for various operations by the UE 10 are stored. The storage unit 140, for example, is constituted by a semiconductor memory, a Hard Disk Drive (HDD), or the like. Additionally, a UE communication path context 142 is stored in the storage unit 140.

The UE communication path context 142 is an information group that is stored in a state of being associated with the communication path that is established by the UE, and may include an access point name (APN), a bearer ID, a PDN connection ID, a Tunnel Endpoint Identifier (TED), base station identification information, service identification information, group identification information, application identification information, application user identification information, a ProSe code, and the like.

The access point name (APN) is identification information that is used to select the PGW 50 in the IP mobile communication network 5, and is identification information that is associated with the PDN 80. In a case where the PDN 80 is constituted differently for every service, such as an IMS or video distribution, the access point name (APN) can also be used as identification information for identifying the service.

The bearer ID is information for identifying a radio bearer that is a wireless communication path between the UE 10 and the UE-R 15 that is established when the UE 10 makes a connection to the UE-R 15. Furthermore, in a case where the UE 10 makes a connection to the eNB 20, the bearer ID may be information for identifying a radio bearer that is a wireless communication path between the UE 10 and the eNB 20 that is established when the UE 10 makes a connection to the eNB 20.

The PDN connection ID is information for identifying a certain PDN connection with a logical bus that is established by the UE 10 between the UE 10 itself and the PGW 50.

The TEID may be information for identifying a tunnel communication path for the user data delivery, which constitutes a PDN connection, and may be information for identifying a tunnel communication path that is established based on a GTP protocol, a mobile IP protocol or a proxy mobile IP protocol. Furthermore, the TEID may be used as identification information for identifying the UE itself in a ProSe service that establishes the direct communication path between the UE 10 itself and different UE.

The base station identification information may be information for identifying the UE-R 15, and may be information for identifying the eNB 20. Furthermore, the base station identification information may be constituted by combining a mobile telecommunications carrier identification code for identifying a mobile telecommunications carrier that provides a communication service, and a base station identification code. Accordingly, the base station identification information can be unique identification information in multiple mobile telecommunication networks that are provided by multiple telecommunications carriers.

The service identification information is information for identifying a service that is provided by the mobile telecommunications carrier using the IP mobile communication network 5. The service identification information may be an APN, and may be service domain identification information such as a Fully Qualified Domain Name (FQDN). Without being limited to this, the service identification information may be identification information that is associated with a service. Additionally, the service may be a voice call service that is based on the IMS, a video distribution service, or the like, and may be a service that provides a group communication. The service identification information may be identification information for identifying such a service.

The group identification information may be information for identifying a group when two or more communication terminals constitute a group and perform the communication among groups. Furthermore, in a case where multiple items of content are delivered to a group, the group identification information may be information for identifying these items of content.

For example, the group identification information may be information for identifying a terminal group when a simulcast call is made among multiple communication terminals. Furthermore, the group identification information may be information for identifying a message for a telephone call. Alternatively, the group identification information may be identification information for identifying terminals to which a video is distributed when the video distribution is performed on multiple communication terminals, as a group, and may be identification information for identifying a distribution image in a case where multiple videos are present.

The group identification information may be an IP multicast address, and may be a Temporary Mobile Subscriber Identify (TMSI) that is a temporary ID which is allocated by the telecommunications carrier and which is used for user authentication. Without being limited to this, the group identification information may be information for identifying a group, such as a mail address.

The application identification information is identification information for identifying an application that is used in the ProSe service in which the UE establishes the direct communication path between the UE itself and the UE-R 15 or different UE.

The application user identification information may be identification information for identifying a user or UE in an application that is identified with the application identification information.

The ProSe code may be information that is transmitted when the UE 10 announces to the UE-R 15 or different UE that is located nearby that the UE 10 itself is located near the UE-R 15 or the different UE. Additionally, the ProSe code may be information that is received when the UE-R 15 or the different UE that is located nearby performs monitoring to know if the UE-R 15 itself or the different UE itself is located near the UE 10. The ProSe code may be constituted by combining the application identification information, information for identifying the UE, and identification information for identifying an operator network such as a PLMN. Additionally, the information for identifying the UE may be subscriber identification information, such as an IMSI, may be identification information, such as the TEID, that is temporarily allocated, and may be the application user identification information or the like.

Moreover, without being limited to the UE 10, multiple communication terminals may be connected to the UE-R 15. Because constitutions of these communication terminals are the same as that of the UE 10, detailed descriptions thereof are omitted.

[1.2.2 Constitution of the UE-R]

A functional constitution of the UE-R 15 according to the present embodiment is described based on FIG. 3. In the UE-R 15, a first interface unit 1510, a second interface unit 1520, a data transfer unit 1530, and a storage unit 1540 are connected to a control unit 1500 through a bus.

The control unit 1500 is a functional unit for controlling the UE-R 15. The control unit 1500 realizes various processing operations by reading and executing various pieces of information or various programs that are stored in the storage unit 1540.

The first interface unit 1510 is a functional unit that establishes the direct communication path between the UE-R 15 itself and a different communication terminal such as the UE 10, using the LTE access scheme and performs the data transmission and reception using the wireless communication. An external antenna 1512 is connected to the first interface unit 1510.

The UE-R 15 can establish the direct communication path between the UE-R 15 itself and a different communication terminal such as the UE 10 through the first interface unit without involving the LTE base station, and can perform the communication.

The second interface unit 1520 is a functional unit that makes a connection to the eNB 20 using the LTE access scheme, establishes the communication path to the PDN 80 through the core network 7, and performs the data transmission and reception using the wireless communication. An external antenna 1522 is connected to the second interface unit 1520.

The UE-R 15 can make a connection to the LTE AN 9 through the second interface unit 1520, can establish the communication path between the UE-R 15 itself and the PDN 80 through the core network 7, and can perform the data transmission and reception, as well.

Moreover, the constitution in which the first interface unit 1510 and the second interface unit 1520 perform the communication through different antennas, respectively, is described referring to the drawing, but a configuration in which one antenna is shared may be possible.

The storage unit 1540 is a functional unit in which programs or pieces of data that are indispensable for various operations by the UE-R 15 are stored. The storage unit 1540, for example, is constituted by the semiconductor memory, the Hard Disk Drive (HDD), or the like. Additionally, a UE-R communication path context 1542 is stored in the storage unit 1540.

The UE-R communication path context 1542 is a first information group that is stored in a state of being associated with the communication path that is established by the UE-R 15, and may include the access point name (APN), the bearer ID, the PDN connection ID, the Tunnel Endpoint Identifier (TEID), the base station identification information, the service identification information, the group identification information, the application identification information, the application user identification information, the ProSe code, and the like.

The access point name (APN) is the identification information that is used to select the PGW 50 in the IP mobile communication network 5, and is the identification information that is associated with the PDN 80. In the case where the PDN 80 is constituted differently for every service, such as an IMS or video distribution, the access point name (APN) can also be used as identification information for identifying the service.

The bearer ID is the information for identifying the radio bearer that is the wireless communication path between the UE 10 and the UE-R 15 that is established when the UE 10 makes a connection to the UE-R 15. Furthermore, in the case where the UE 10 makes a connection to the eNB 20, the bearer ID may be the information for identifying the radio bearer that is the wireless communication path between the UE 10 and the eNB 20 that is established when the UE 10 makes a connection to the eNB 20.

The PDN connection ID is information for identifying a certain PDN connection with a logical bus that is established by the UE 10 between the UE 10 itself and the PGW 50.

The TEID may be the information for identifying the tunnel communication path for the user data delivery, which constitutes the PDN connection, and may be the information for identifying the tunnel communication path that is established based on the GTP protocol, the mobile IP protocol or the proxy mobile IP protocol. Furthermore, the TEID may be used as the identification information for identifying the UE itself in the ProSe service that establishes the direct communication path between the UR-R 15 itself and different UE.

The base station identification information may be the information for identifying the UE-R 15, and may be the information for identifying the eNB 20. Furthermore, the base station identification information may be constituted by combining the mobile telecommunications carrier identification code for identifying the mobile telecommunications carrier that provides the communication service, and the base station identification code. Accordingly, the base station identification information can be the unique identification information in the multiple mobile telecommunication networks that are provided by the multiple telecommunications carriers.

The service identification information is the information for identifying the service that is provided by the mobile telecommunications carrier using the IP mobile communication network 5. The service identification information may be the APN, and may be the service domain identification information such as the Fully Qualified Domain Name (FQDN). Without being limited to this, the service identification information may be identification information that is associated with a service. Additionally, the service may be the voice call service that is based on the IMS, the video distribution service, or the like, and may be the service that provides the group communication. The service identification information may be the identification information for identifying such a service.

The group identification information may be the information for identifying the group when the two or more communication terminals constitute the group and perform the communication among groups. Furthermore, in the case where the multiple items of content are delivered to the group, the group identification information may be the information for identifying these items of content.

For example, the group identification information may be the information for identifying the terminal group when the simulcast call is made among the multiple communication terminals. Furthermore, the group identification information may be the information for identifying the message for the telephone call. Alternatively, the group identification information may be the identification information for identifying the terminals to which the video is distributed when the video distribution is performed on the multiple communication terminals, as the group, and may be the identification information for identifying the distribution image in the case where the multiple video are present.

The group identification information may be the IP multicast address, and may be the Temporary Mobile Subscriber Identify (TMSI) that is the temporary ID which is allocated by the telecommunications carrier and which is used for the user authentication. Without being limited to this, the group identification information may be information for identifying the group, such as the mail address.

The application identification information is the identification information for identifying the application that is used in the ProSe service in which the UE-R 15 establishes the direct communication path between the UE-R 15 itself and different UE.

The application user identification information may be the identification information for identifying the user or the UE-R 15 in an application that is identified with the application identification information.

The ProSe code may be the information that is transmitted when the UE announces to different UE that is located nearby that the UE itself is located near the different UE. Additionally, the ProSe code may be the information that is received when the different UE that is located nearby performs the monitoring to know if the different UE itself is located near the UE. The ProSe code may be constituted by combining the application identification information, the information for identifying the UE, and the identification information for identifying the operator network such as the PLMN. Additionally, the information for identifying the UE may be the subscriber identification information, such as the IMSI, may be the identification information, such as the TEID, that is temporarily allocated, and may be the application user identification information or the like.

The UE-R communication path context 1542 may be retained for every communication path. For example, the UE-R communication path context 1542 may be retained for each of the direct communication path for making a connection to the UE 10 and the communication paths for making a connection to the eNB 20 and for making a connection to the PGW 50.

Here, the base station information in the UE-R communication path context 1542 for the direct communication path may be the information for identifying the UE-R 15, and the base station information in the UE-R communication path context 1542 for the communication paths for making a connection to the eNB 20 and for making a connection to the PGW 50 may be the information for identifying the eNB 20.

Additionally, information for identifying the UE-R 15 may be retained in the UE-R communication path context 1542. The information for identifying the UE-R 15 may be the subscriber identification information, such as the International Mobile Subscriber Identity (IMSI), that is associated with the UE-R 15, may be an IP address that is allocated to the UE-R 15, and may be information, such as the Fully Qualified Domain Name (FQDN), that is associated with the UE-R 15.

Additionally, information for identifying the position management device may be stored in the UE-R communication path context 1542. The information for identifying the position management device may be an IP address that is allocated to the position management device, and may be information, such as the Fully Qualified Domain Name (FQDN), that is associated with the position management device. Furthermore, the information for identifying the position management device may be a Globally Unique MME Identifier (GMMEI) that has the global uniqueness, and may be a Global Unique Temporary Identity (GUTI) that is constituted from a GUTI, and a Temporary Mobile Subscriber Identify (TMSI) that is a temporary ID which is used for the user authentication and which is allocated by the telecommunications carrier.

The data transfer unit 1530 is a functional unit that transfers reception data that is received through the first interface unit 1510 from the UE 10, to the IP mobile communication network through the second interface unit 1520, and transfers reception data that is received through the second interface unit 1520, and that is destined for the UE 10, to the UE 10 through the first interface unit 1510.

Moreover, without being limited to the UE 10, the multiple communication terminals may be connected to the UE-R 15. Furthermore, without being limited to the UE-R 15, multiple communication terminals, each of which is equipped with a relay function, may be connected to the eNB 20. Because constitutions of these communication terminals, of which is equipped with the relay function, are the same as that of the UE-R 15, detailed descriptions thereof are omitted.

[1.2.3 Constitution of the eNB]

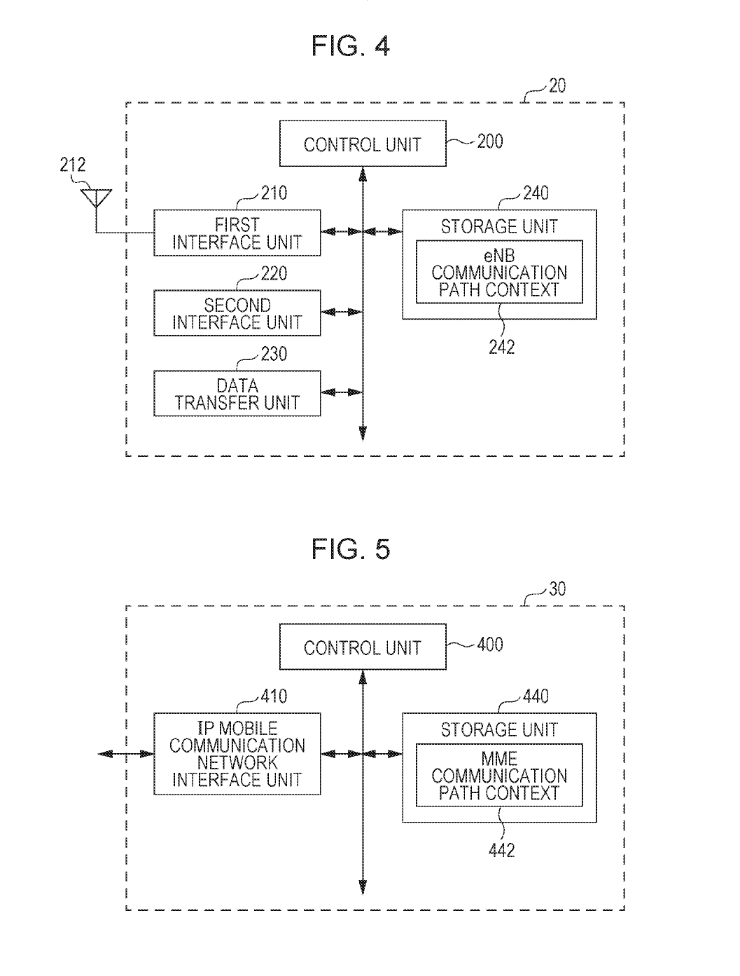

Subsequently, a functional constitution of the eNB 20 according to the present embodiment is described based on FIG. 4. In the eNB 20, a first interface unit 210, a second interface unit 220, a data transfer unit 230, and a storage unit 240 are connected to a control unit 200 through a bus.

The control unit 200 is a functional unit for controlling the eNB 20. The control unit 200 realizes various processing operations by reading and executing various pieces of information or various programs that are stored in the storage unit 240.

The first interface unit 210 is a functional unit that establishes the direct communication path between the eNB 20 itself and the UE-R 15 or the UE 10, using the LTE access scheme and performs the data transmission and reception using the wireless communication. An external antenna 212 is connected to the first interface unit 210.

The second interface unit 220 is connected to the core network 7 using a wired connection. The connection to the core network 7 may be made using the Ethernet (a registered trademark), an optical fiber cable, or the like.

The storage unit 240 is a functional unit in which programs or pieces of data that are indispensable for various operations by the eNB 20 are stored. The storage unit 240, for example, is constituted by the semiconductor memory, the Hard Disk Drive (HDD), or the like. Additionally, an eNB communication path context 242 is stored in the storage unit 240.

The eNB communication path context 242 is an information group that is stored in a state of being associated with the communication path that is established between the eNB 20 itself and the UE-R 15 or the UE 10, and may include the access point name (APN), the bearer ID, the PDN connection ID, the Tunnel Endpoint Identifier (TEID), the base station identification information, the service identification information, the group identification information, and the like.

The access point name (APN) is the identification information that is used to select the PGW 50 in the IP mobile communication network 5, and is the identification information that is associated with the PDN 80. In the case where the PDN 80 is constituted differently for every service, such as the IMS or the video distribution, the access point name (APN) can also be used as the identification information for identifying the service.

The bearer ID is the information for identifying the radio bearer that is the wireless communication path between the UE 10 and the UE-R 15 that is established when the UE 10 makes a connection to the UE-R 15. Furthermore, in the case where the UE 10 makes a connection to the eNB 20, the bearer ID may be the information for identifying the radio bearer that is the wireless communication path between the UE 10 and the eNB 20 that is established when the UE 10 makes a connection to the eNB 20.

The PDN connection ID is the information for identifying a certain PDN connection with the logical bus that is established by the UE 10 between the UE 10 itself and the PGW 50.

The TEID may be the information for identifying the tunnel communication path for the user data delivery, which constitutes the PDN connection, and may be the information for identifying the tunnel communication path that is established based on the GTP protocol, the mobile IP protocol or the proxy mobile IP protocol.

The base station identification information may be the information for identifying the UE-R 15, and may be the information for identifying the eNB 20. Furthermore, the base station identification information may be constituted by combining the mobile telecommunications carrier identification code for identifying the mobile telecommunications carrier that provides the communication service, and the base station identification code. Accordingly, the base station identification information can be the unique identification information in the multiple mobile telecommunication networks that are provided by the multiple telecommunications carriers.

Furthermore, the base station identification information may be an IP address that is allocated to the base station, and may be identification information such as the Fully Qualified Domain Name (FQDN).

Furthermore, the base station identification information may be the information for identifying the UE-R 15, may be the IP address that is allocated to the UE-R 15, and may be the identification information such as the Fully Qualified Domain Name (FQDN).

The service identification information is the information for identifying the service that is provided by the mobile telecommunications carrier using the IP mobile communication network 5. The service identification information may be the APN, and may be the service domain identification information such as the Fully Qualified Domain Name (FQDN). Without being limited to this, the service identification information may be identification information that is associated with a service. Additionally, the service may be the voice call service that is based on the IMS, the video distribution service, or the like, and may be the service that provides the group communication. The service identification information may be identification information for identifying such a service.

The group identification information may be the information for identifying the group when the two or more communication terminals constitute the group and perform the communication among groups. Furthermore, in the case where the multiple items of content are delivered to the group, the group identification information may be the information for identifying these items of content.

For example, the group identification information may be the information for identifying the terminal group when the simulcast call is made among the multiple communication terminals. Furthermore, the group identification information may be the information for identifying the message for the telephone call. Alternatively, the group identification information may be identification information for identifying terminals to which a video is distributed when the video distribution is performed on multiple communication terminals, as a group, and may the identification information for identifying the distribution image in the case where the multiple videos are present.

The group identification information may be the IP multicast address, and may be the Temporary Mobile Subscriber Identify (TMSI) that is the temporary ID which is allocated by the telecommunications carrier and which is used for the user authentication. Without being limited to this, the group identification information may be information for identifying a group, such as a mail address.

The eNB communication path context 242 may be retained for every communication path. For example, the eNB communication path context 242 may be retained for each of the communication path between the eNB 20 itself and the UE-R 15 and the communication path between the eNB itself and the communication terminal that has a different relay function.

Here, each of the information for identifying the UE-R 15 and the information for identifying the eNB 20 may be included in the base station information in a communication path context for the direct communication path.

The data transfer unit 230 is a functional unit that transfers reception data that is received through the first interface unit 210 from the UE-R 15, to the IP mobile communication network through the second interface unit 220, and transfers reception data that is received through the second interface unit 220 and that is destined for the UE 10, to the UE 10 using the first interface unit 210, through the UE-R 15.

[1.2.4 Constitution of the MME]

The MME 30 is the position management device that determines whether or not establishment of communication path for the UE 10 or service provision is approved.

FIG. 5 illustrates a functional constitution of the MME 30. In the MME 30, an IP mobile communication network interface unit 410 and the storage unit 440 are connected to a control unit 400 through a bus.

The control unit 400 is a functional unit for controlling the MME 30. The control unit 400 realizes various processing operations by reading and executing various pieces of information that are stored in the storage unit 440.

The IP mobile communication network interface unit 410 is a functional unit that is indispensable for the MME 30 to make a connection to the IP mobile communication network 5.

The storage unit 440 is a functional unit in which programs or pieces of data that are indispensable for various operations by the UE 10 are recorded. The storage unit 440, for example, is constituted by the semiconductor memory, the Hard Disk Drive (HDD), or the like. Additionally, an MME communication path context 442 is stored in the storage unit 440.

The MME communication path context 442 is an information group that is stored in a state of being associated with the communications path that is established between the UE-R 15 and the UE 10, and may include the access point name (APN), the bearer ID, the PDN connection ID, the Tunnel Endpoint Identifier (TEID), terminal device identification information, ProSe Server identification information, the base station identification information, the service identification information, the group identification information, and the like.

The access point name (APN) is the identification information that is used to select the PGW 50 in the IP mobile communication network 5, and is the identification information that is associated with the PDN 80. In the case where the PDN 80 is constituted differently for every service, such as the IMS or the video distribution, the access point name (APN) can also be used as the identification information for identifying the service.

The bearer ID is the information for identifying the radio bearer that is the wireless communication path between the UE 10 and the UE-R 15 that is established when the UE 10 makes a connection to the UE-R 15. Furthermore, in the case where the UE 10 makes a connection to the eNB 20, the bearer ID may be the information for identifying the radio bearer that is the wireless communication path between the UE 10 and the eNB 20 that is established when the UE 10 makes a connection to the eNB 20.

The PDN connection ID is the information for identifying a certain PDN connection with the logical bus that is established by the UE 10 between the UE 10 itself and the PGW 50.

The TEID may be the information for identifying the tunnel communication path for the user data delivery, which constitutes the PDN connection, and may be the information for identifying the tunnel communication path that is established based on the GTP protocol, the mobile IP protocol or the proxy mobile IP protocol.

The terminal device identification information may be the information for identifying the UE-R 15. Furthermore, the information for identifying the UE-R 15 may be the subscriber identification information, such as the International Mobile Subscriber Identity (IMSI), that is associated with the UE-R 15, may be the IP address that is allocated to the UE-R 15, and may be the information, such as the Fully Qualified Domain Name (FQDN), that is associated with the UE-R 15. Additionally, multiple pieces of identification information for identifying the UE-R 15 may be stored.

The ProSe server identification information may be information for identifying the ProSe Server 90. Furthermore, the information for identifying the ProSe Server 90 may be an IP address that is allocated to the ProSe Server 90, and may be information, such as the Fully Qualified Domain Name (FQDN), that is associated with the ProSe Server 90.

Furthermore, the MME 30 may store the terminal device identification information and the information for identifying the ProSe Server 90, in a state of being associated with each other. Accordingly, the ProSe Server that manages a service provided to the terminal device may be stored, and the terminal device to which the ProSe Server provides the service may be stored.

The base station identification information may be the information for identifying the UE-R 15, and may be the information for identifying the eNB 20. Furthermore, the base station identification information may be constituted by combining the mobile telecommunications carrier identification code for identifying the mobile telecommunications carrier that provides the communication service, and the base station identification code. Accordingly, the base station identification information can be the unique identification information in the multiple mobile telecommunication networks that are provided by the multiple telecommunications carriers.

The service identification information is the information for identifying the service that is provided by the mobile telecommunications carrier using the IP mobile communication network 5. The service identification information may be the APN, and may be the service domain identification information such as the Fully Qualified Domain Name (FQDN). Without being limited to this, the service identification information may be identification information that is associated with a service. Additionally, the service may be the voice call service that is based on the IMS, the video distribution service, or the like, and may be the service that provides the group communication. The service identification information may be identification information for identifying such a service.

The group identification information may be the information for identifying the group when the two or more communication terminals constitute the group and perform the communication among groups. Furthermore, in the case where the multiple items of content are delivered to the group, the group identification information may be the information for identifying these items of content.

For example, the group identification information may be the information for identifying the terminal group when the simulcast call is made among the multiple communication terminals. Furthermore, the group identification information may be the information for identifying the message for the telephone call. Alternatively, the group identification information may be the identification information for identifying the terminals to which the video is distributed when the video distribution is performed on the multiple communication terminals, as the group, and may be the identification information for identifying the distribution image in the case where the multiple videos are present.

The group identification information may be the IP multicast address and may be the Temporary Mobile Subscriber Identify (TMSI) that is the temporary ID which is allocated by the telecommunications carrier and which is used for the user authentication. Without being limited to this, the group identification information may be information for identifying a group, such as a mail address.

The MME communication path context 442 may be retained for every communication path. For example, the MME communication path context 442 may be retained for each of the communication path that is established by the UE 10 between the UE 10 itself and the UE-R 15 and the communication path that is established by the UE 10 between the UE 10 itself and the communication terminal that has a different relay function.

Here, each of the information for identifying the UE-R 15 and the information for identifying the eNB 20 to which the UE-R 15 makes a connection may be included in the base station information in the communication path context for the direct communication path.

Furthermore, the information group described above may be stored as an information element of a Mobility Management (MM) context.

[1.2.5 Constitution of the Prose Server]

The ProSe Server 90 is a server apparatus that provides a service, such as establishment of the direct communication path or detection of a neighboring terminal, to the UE-R 15 or the UE 10.

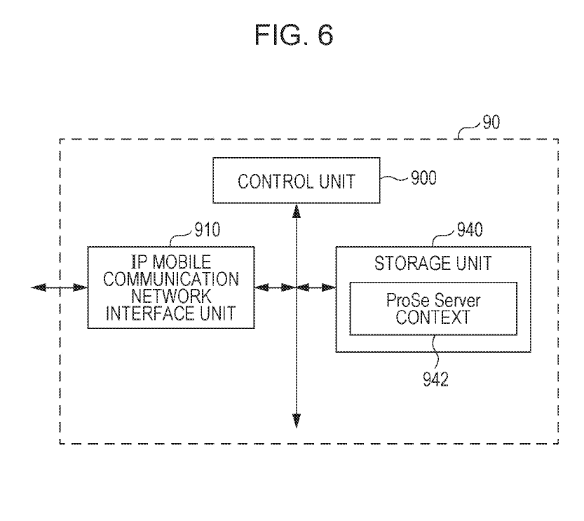

FIG. 6 illustrates a functional constitution of the ProSe Server 90. In the ProSe Server 90, an IP mobile communication network interface unit 910 and a storage unit 940 is connected to a control unit 900 through a bus.

The control unit 900 is a functional unit for controlling the UE 10. The control unit 900 realizes various processing operations by reading and executing various pieces of information that are stored in the storage unit 940.

The IP mobile communication network interface unit 910 is a functional unit that is indispensable for the ProSe Server 90 to make a connection to the IP mobile communication network 5.

The storage unit 940 is a functional unit in which programs or pieces of data that are indispensable for various operations by the UE 10 are recorded. The storage unit 940, for example, is constituted by the semiconductor memory, the Hard Disk Drive (HDD), or the like.

Additionally, a ProSe Server communication path context 942 is stored in the storage unit 940.

The ProSe Server communication path context 942 is an information group that is stored in a state of being associated with the direct communication path that is established between the UE-R 15 and the UE 10, and may include the access point name (APN), the bearer ID, the PDN connection ID, the Tunnel Endpoint Identifier (TEID), the base station identification information, the service identification information, the group identification information, and the like.

The access point name (APN) is the identification information that is used to select the PGW 50 in the IP mobile communication network 5, and is the identification information that is associated with the PDN 80. In the case where the PDN 80 is constituted differently for every service, such as the IMS or the video distribution, the access point name (APN) can also be used as the identification information for identifying the service.

The bearer ID is the information for identifying the radio bearer that is the wireless communication path between the UE 10 and the UE-R 15 that is established when the UE 10 makes a connection to the UE-R 15. Furthermore, in the case where the UE 10 makes a connection to the eNB 20, the bearer ID may be the information for identifying the radio bearer that is the wireless communication path between the UE 10 and the eNB 20 that is established when the UE 10 makes a connection to the eNB 20.

The PDN connection ID is the information for identifying a certain PDN connection with the logical bus that is established by the UE 10 between the UE 10 itself and the PGW 50.

The TEID may be the information for identifying the tunnel communication path for the user data delivery, which constitutes the PDN connection, and may be the information for identifying the tunnel communication path that is established based on the GTP protocol, the mobile IP protocol or the proxy mobile IP protocol.

The base station identification information may be the information for identifying the UE-R 15, and may be the information for identifying the eNB 20. Furthermore, the base station identification information may be constituted by combining the mobile telecommunications carrier identification code for identifying the mobile telecommunications carrier that provides the communication service, and the base station identification code. Accordingly, the base station identification information can be the unique identification information in the multiple mobile telecommunication networks that are provided by the multiple telecommunications carriers.

The service identification information is the information for identifying the service that is provided by the mobile telecommunications carrier using the IP mobile communication network 5. The service identification information may be the APN, and may be the service domain identification information such as the Fully Qualified Domain Name (FQDN). Without being limited to this, the service identification information may be identification information that is associated with a service. Additionally, the service may be the voice call service that is based on the IMS, the video distribution service, or the like, and may be the service that provides the group communication. The service identification information may be identification information for identifying such a service.

The group identification information may be the information for identifying the group when the two or more communication terminals constitute the group and perform the communication among groups. Furthermore, in the case where the multiple items of content are delivered to the group, the group identification information may be the information for identifying these items of content.

For example, the group identification information may be the information for identifying the terminal group when the simulcast call is made among the multiple communication terminals. Furthermore, the group identification information may be the information for identifying the message for the telephone call. Alternatively, the group identification information may be identification information for identifying terminals to which a video is distributed when the video distribution is performed on multiple communication terminals, as a group, and may the identification information for identifying the distribution image in the case where the multiple videos are present.

The group identification information may be the IP multicast address, and may be the Temporary Mobile Subscriber Identify (TMSI) that is the temporary ID which is allocated by the telecommunications carrier and which is used for the user authentication. Without being limited to this, the group identification information may be information for identifying a group, such as a mail address.

The ProSe Server communication path context 942 may be retained for every communication path. For example, the ProSe Server communication path context 942 may be retained for each of the communication path that is established by the UE 10 between the UE 10 itself and the UE-R 15 and the communication path that is established by the UE 10 between the UE 10 itself and the communication terminal that has a different relay function.

Here, each of the information for identifying the UE-R 15 and the information for identifying the eNB 20 to which the UE-R 15 makes a connection may be included in the base station information in the communication path context for the direct communication path.

Additionally, the ProSe Server 90 may retain the information for identifying the UE-R 15 in the ProSe Server communication path context 942, in a state of being included in the information for identifying the UE-R 15. The information for identifying the UE-R 15 may be the subscriber identification information, such as the International Mobile Subscriber Identity (IMSI), that is associated with the UE-R 15, may be the IP address that is allocated to the UE-R 15, and may be the information, such as the Fully Qualified Domain Name (FQDN), that is associated with the UE-R 15.

Additionally, the information for identifying the position management device may be stored in the ProSe Server communication path context 942. The information for identifying the position management device may be the IP address that is allocated to the position management device, and may be the information, such as the Fully Qualified Domain Name (FQDN), that is associated with the position management device. Furthermore, the information for identifying the position management device that has the global uniqueness may be the Globally Unique MME Identifier (GMMEI), and may be the Global Unique Temporary Identity (GUTI) that is constituted from the GUTI, and the temporary Mobile Subscriber Identify (TMSI) that is the temporary ID which is used for the user authentication and which is allocated by the telecommunications carrier.

The ProSe Server 90 may store identification information for identifying such a terminal and information for identifying the position management device, in a state of being associated with each other. Additionally, accordingly, the position management device may perform the position management of the terminal device.

[1.3 Description of Processing]

Subsequently, an embodiment of specific processing in the mobile communication system described above is described. The present embodiment is made up of a procedure for a connection by the UE 10 to the UE-R 15, a procedure for a connection by the UE-R 15 to the IP mobile communication network 5, a procedure in which the UE 10 establishes the communication path through the UE-R 15, and the like. Moreover, as will be hereinafter described, LTE Direct in which the direct connection path is established between the UE 10 and the UE-R 15 using the LTE communication scheme is expressed as LTE (D).

[1.3.1 UE Connection Procedure]

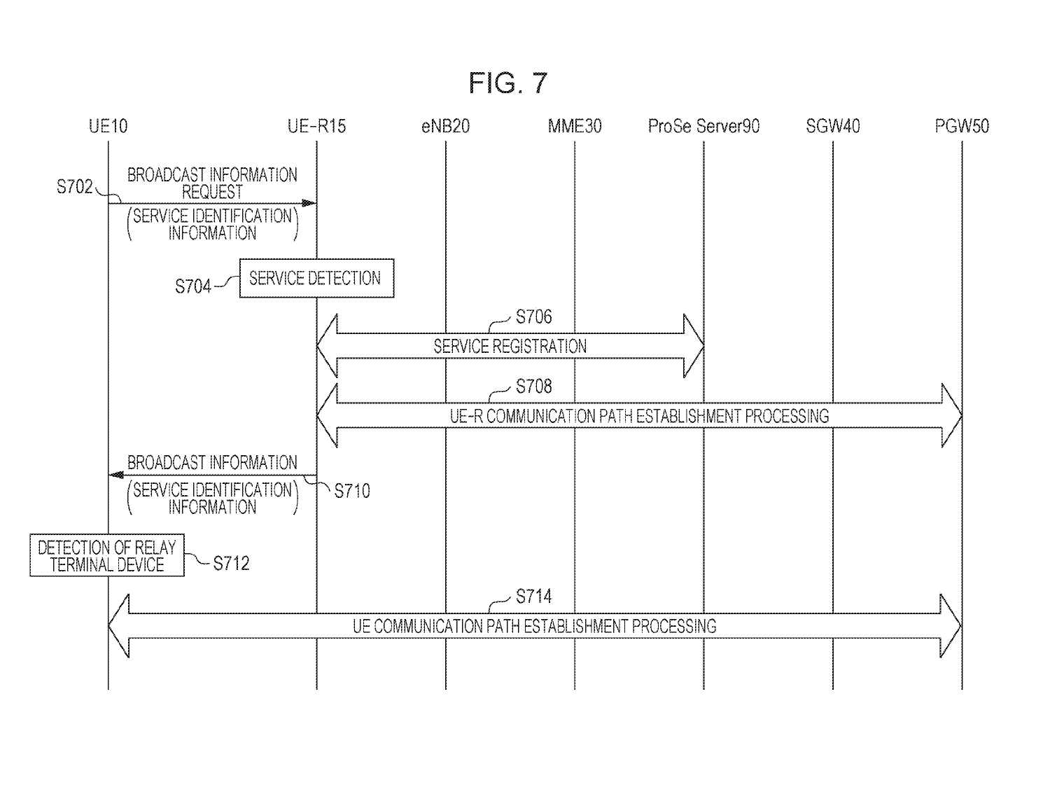

An example of a procedure in which the UE 10 makes a connection to the UE-R 15 is described referring to FIG. 7. When it is detected that the eNB 20 is not in a serving area, in which case the eNB 20 is difficult to detect, the UE 10 may be caused to start the procedure. Alternatively, the UE 10 may be in a state where the UE detects the eNB 20 and makes a connection to the IP mobile communication network through the eNB 20 based on the procedure in the related art.

Alternatively, when the user performs a terminal operation in order to start a service, the UE 10 may be caused to start the procedure. For example, with a user operation, such as an operation of starting the group communication, the procedure may be started.

First, when it is detected that with the method described above, the procedure is started, the UE 10 transmits a broadcast information request message to the UE-R 15 (S702). The broadcast information request message is transmitted in order to detect the UE-R 15 that is located nearby.

Means for transmitting a broadcast information request may be through broadcasting. The information for identifying the UE-R 15 may be retained in advance and may be unicast to the UE-R 15.

Included in the broadcast information request message may be the information for identifying the UE 10, the access point name (APN), the service identification information, the group identification information, and the like.

The access point name (APN) is the identification information that is used to select the PGW 50 in the IP mobile communication network 5, and is the identification information that is associated with the PDN 80. In the case where the PDN 80 is constituted differently for every service, such as the IMS or the video distribution, the access point name (APN) can also be used as the identification information for identifying the service.

The service identification information is the information for identifying the service that is provided by the mobile telecommunications carrier using the IP mobile communication network 5. The service identification information may be the APN, and may be the service domain identification information such as the Fully Qualified Domain Name (FQDN). Without being limited to this, the service identification information may be identification information that is associated with a service. Additionally, the service may be the voice call service that is based on the IMS, the video distribution service, or the like, and may be the service that provides the group communication. The service identification information may be identification information for identifying such a service.

The group identification information may be the information for identifying the group when the two or more communication terminals constitute the group and perform the communication among groups. Furthermore, in the case where the multiple items of content are delivered to the group, the group identification information may be the information for identifying these items of content.

For example, the group identification information may be the information for identifying the terminal group when the broadcast call is made among the multiple communication terminals. Alternatively, the group identification information may be the information for identifying the message for the telephone call. Alternatively, the group identification information may be the identification information for identifying the terminals to which the video is distributed when the video distribution is performed on the multiple communication terminals, as the group, and may be the identification information for identifying the distribution image in the case where the multiple videos are present.

The group identification information may be the IP multicast address, and may be the Temporary Mobile Subscriber Identify (TMSI) that is the temporary ID which is allocated by the telecommunications carrier and which is used for the user authentication. Without being limited to this, the group identification information may be information for identifying a group, such as a mail address.

The UE-R 15 receives the broadcast information request, and performs service detection (S704).

The service detection may be detected based on the information for identifying the UE 10, which is included in the broadcast information request message, the access point name (APN), the service identification information, and the group identification information.

For example, a correspondence between a service that can be provided to the UE 10 and the APN that is associated with the service may be retained in advance and it may be detected whether or not the APN that is received from the UE 10 is a service that can be provided.

Furthermore, the correspondence between the service that can be provided to the UE 10 and the service identification information that is associated with the service may be retained in advance and it may be detected whether or not the service identification information that is received from the UE 10 is a service that can be provided.

Furthermore, the correspondence between the service that can be provided to the UE 10 and the group identification information that is associated with the service may be retained in advance and it may be detected whether or not the group identification information that is received from the UE 10 is a service that can be provided.

Without being limited to this, the APN, the service identification information, and the group identification information may be arbitrarily combined and combinations of them may be detected.

Furthermore, the UE-R 15 executes a service registration procedure between the UE-R 15 itself and the ProSe Server 90 (S706), and, based on the result, it may be detected whether or not a service that can be provided to the UE 10 is available.

Additionally, the UE-R 15 executes registration of the service that is provided to the UE 10 with the ProSe Server 90. The service registration procedure will be described in detail below.

After the service is detected, the UE-R may select the PGW 50 according to the service, may execute UE-R communication path establishment processing, and may establish the communication path between the UE-R itself and the PGW 50 (S708).

Specifically, the UE-R 15 establishes the PDN connection between the UE-R 15 itself and the PGW 50. In a UE-R communication path establishment procedure, an establishment request message may be transmitted to the IP communication network based on the detection of the service, and an establishment procedure may be started.

More specifically, a PDN connection establishment request message is transmitted to the MME 30 and a response message in response to the PDN connection establishment request message, which approves the establishment of the PDN connection, is received, thereby establishing the communication path.

The information for identifying the UE 10, the access point name (APN), the service identification number, the group identification number, and the like may be included in the PDN connection establishment message.

Additionally, the access point name (APN), the bearer ID, the PDN connection ID, the Tunnel Endpoint Identifier (TEID), the base station identification information, the service identification information, the group identification information, and the like may be in the response message, and based on the response message, a UE-R communication path context may be retained. Furthermore, the UE-R 15 may manage the UE-R communication path context and the established communication path, in a state of being associated with each other.

For selection of the PGW 50, the PGW 50 that is associated with a service may be retained in advance. Furthermore, the MME 30 may in advance retain the PGW 50 that is associated with the service, the PGW 50 may transmit control information for making an inquiry, to the MME 30, and as a response to the control information, may acquire information on the PGW 50.

In a case where the detection of the service, the registration of the service, and the establishment of the PDN connection that is associated with the service are completed, the UE-R 15 transmits broadcast information to the UE 10 (S710).

The means for transmitting the broadcast information transmission may be through broadcasting. The information for identifying the UE 10 may be retained in advance and may be unicast to the UE 10.

Included in the broadcast information message may be the information for identifying the UE 10, the access point name (APN), the service identification information, the group identification information, and the like.

Accordingly, by transmitting the broadcast information, the UE-R 15 can notify the UE 10 of the service that can be provided.

Additionally, the UE-R 15 may transmit load information or the like, in a state of being included in the broadcast information message. The load information may be information that represents load indicating a processing situation of the UE-R15, may be the number of communication terminals that make connections, and in a case where relay processing of multiple terminals is performed, may be processing load information thereon. Additionally, the load information may be class information representing a processing load.

Furthermore, in a case where the relay processing is not performed, the UE-R 15 may disable the relay processing. Additionally, the relay function may be disabled based on reception of the broadcast information request message. Furthermore, the relay function may be disabled based on the detection of the service.

A broadcast information request that is transmitted from the UE 10 may be received not only by the UE-R 15, but also by a terminal device that has one other than the relay function described above. In the same manner as in the UE-R 15, each terminal may perform the detection of the service, the registration of the service, and the establishment of the communication path, and thus may transmit the broadcast information.

The UE 10 receives the broadcast information and detects the UE-R 15 that is able to provide the service (S712).

Whether or not the service is able to be provided may be detected based on the identification information, the access point name (APN), the service identification information, and the group identification information, which are included in the broadcast information message, and the relay terminal device may be selected.

For example, the correspondence between the service that can be provided to the UE 10 and the APN that is associated with the service may be retained in advance and it may be detected whether or not the APN that is received by the UE 10 is a service that is indispensable.

Furthermore, the correspondence between the service that can be provided to the UE 10 and the service identification information that is associated with the service may be retained in advance and it may be detected whether or not the service identification information that is received by the UE 10 is a service that is indispensable.

Furthermore, the correspondence between the service that can be provided to the UE 10 and the group identification information that is associated with the service may be retained in advance and it may be detected whether or not the group identification information that is received by the UE 10 is a service that is indispensable.

Along with receiving the broadcast information from the UE-R 15, the UE 10 may receive the broadcast information from the terminal device that has one other than the relay function described above.

In a case where multiple pieces of broadcast information received, a connection destination may be selected based on the identification information, the access point name (APN), the service identification information, and the group identification information, which are included in each piece of broadcast information.

In this manner, the terminal device that has the relay function may be selected based on the service that is provided.

Furthermore, in a case where multiple terminal devices, each of which has the relay function of providing the service that is indispensable to the UE 10, are present, the connection destination may be selected based on the load information or the like that is included in each piece of broadcast information.

Accordingly, the UE 10 can select the terminal device that has the relay function, which has a less load. In the terminal device that has the relay function, terminals that make connections can be distributed, an excessive deviation can be reduced. Because of this, the processing load can be optimized.

Furthermore, the UE 10 may select the UE-R 15 immediately after receiving the broadcast information. The UE 10 may perform a timer, and thus may keep a state of receiving the broadcast information for a fixed time and may wait for the broadcast information from a different terminal device.

The time for which the timer is performed may be retained in advance, and the UE-R 15 may transmit a value that is determined based on a communications carrier's policy, in a state of being included in the broadcast information.

In this manner, the UE 10 can select an optimal relay terminal device from among relay terminal devices that are able to be connected, based on the server that the UE 10 requests, the group identification information for the group communication, or the like.

Additionally, the UE 10 may determine selection of information for identifying a service that is requested by the UE and information for identifying the group information, using any information that is associated with the service or the group and that is notified from the IP mobile communication network 5, such as the APN, the IP multicast address, the TMSI, the FQDN, or a combination of such pieces of information. Additionally, the UE 10 may select the relay terminal device based on a result of such a determination.

According to the present embodiment, an example is described in which the UE 10 selects the UE-R 15. The UE 10 selects the UE-R 15, performs UE communication path establishment processing, and establishes the communication path (S714).

In the UE communication path establishment processing, based on detection of the UE-R, the UE 10 transmits the establishment request message, and starts the establishment procedure.

More specifically, the PDN connection establishment request message may be transmitted to the MME 30 through the UE-R 15 and the response message in response to the PDN connection establishment request message, which approves the establishment of the PDN connection may be received, thereby establishing the communication path.

Furthermore, the PDN connection establishment request message may be transmitted to the UE-R 15, and the response message in response to the PDN connection establishment request message, which approves the establishment of the PDN connection may be received, thereby establishing the communication path.

The information for identifying the UE 10, the access point name (APN), the service identification number, the group identification number, and the like may be included in the PDN connection establishment message.

Additionally, the access point name (APN), the bearer ID, the PDN connection ID, the Tunnel Endpoint Identifier (TEID), the base station identification information, the service identification information, the group identification information, and the like may be in the response message, and based on the response message, a UE communication path context may be retained. Additionally, information, such as an IP address or QoS information may be included in the response message. Furthermore, the UE 10 may manage the UE communication path context and the established communication path, in a state of being associated with each other.

The response message may be transmitted by the UE-R 15 to the UE 10 based on information on the approval of the establishment of the communication path by the MME 30 or the ProSe Server 90.

Alternatively, the response message may be transmitted by the MME 30 to the UE 10. Alternatively, the response message may be transmitted by the ProSe Server 90 to the UE 10.

As an response to the PDN connection establishment request message that is transmitted by the UE 10, the UE-R 15 may acquire the access point name (APN), the bearer ID, the PDN connection ID, the Tunnel Endpoint Identifier (TEID), the base station identification information, the service identification information, the group identification information, the IP address, and the QoS information, which are determined or allocated based on the determination of the approval of the PDN connection establishment by the MME 30 or the ProSe Server 90. Transmission of the response to the UE-R 15 may be performed by any one of the eNB 20, the MME 30, the ProSe Server 90, and the SGW 40.

Additionally, the UE-R 15 may acquire and retain the received information group as information in the communication path context.

The UE 10 may establish the direct communication path that is based on LTE(D), between the UE 10 itself and the UR-R 15, and the UE-R 15 may manage the communication path that is established with the UE-R communication path establishment processing, and the communication path that is established with the UE communication path establishment processing, in a state of being associated with each other, and may perform the relay processing.

More specifically, the UE-R communication path contexts that correspond to the communication paths, respectively, may be retained in a state of being associated with each other, and data, which is transmitted to the UE-R 15 through the communication path that is established by the UE 10 with the UE communication path establishment processing, may be transmitted to the core network 7 through the communication path that is established with the UE-R communication path establishment processing. Furthermore, the data that is destined for the UE 10, which is transmitted through the communication path that is established with the UE-R communication path establishment processing, may be received from the core network 7, and may be transmitted to the UE 10 through the communication path that is established with the UE communication path establishment processing.

With the procedure described above, the UE 10 can select the UE-R 15 from among multiple communication terminals, each of which has the relay function, and can establish the communication path through the UE-R 15. Additionally, with transfer processing by the UE-R 15, the UE 10 can start the transmission and reception of the data to and from the PDN 80.

[1.3.1.1 Service Registration Procedure]

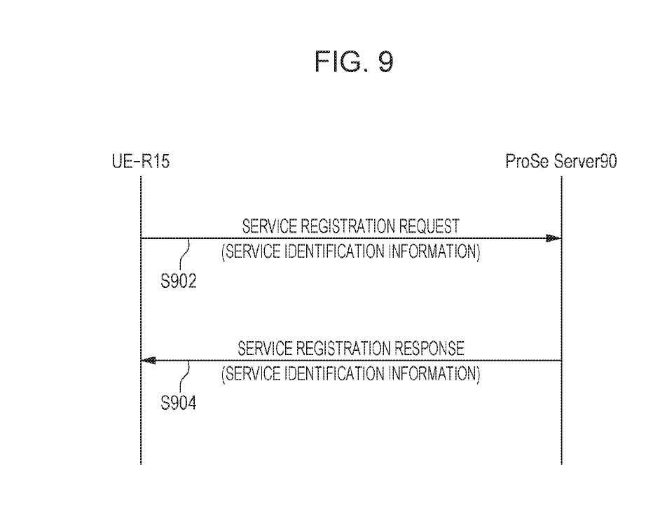

A specific procedure of the service registration procedure (S706) that is described referring to FIG. 7 is described referring to FIG. 9.

The UE-R 15 transmits a service registration request to the ProSe Server 90, and makes a registration request for to the service that is provided, to the terminal device that makes a connection along the direct communication path between the terminal device itself and the UE-R (S902).

As described in FIG. 7, the reception of the broadcast information request message that is transmitted by the UE 10 may trigger transmission of a service registration request message.

Included in the message are the information for identifying the UE 10, the access point name (APN), the service identification information, the group identification information, the application identification information, the application user identification information, the ProSe Server, and the like.

The access point name (APN) is the identification information that is used to select the PGW 50 in the IP mobile communication network 5, and is the identification information that is associated with the PDN 80. In the case where the PDN 80 is constituted differently for every service, such as the IMS or the video distribution, the access point name (APN) can also be used as the identification information for identifying the service.

The service identification information is the information for identifying the service that is provided by the mobile telecommunications carrier using the IP mobile communication network 5. The service identification information may be the APN, and may be the service domain identification information such as the Fully Qualified Domain Name (FQDN). Without being limited to this, the service identification information may be identification information that is associated with a service. Additionally, the service may be the voice call service that is based on the IMS, the video distribution service, or the like, and may be the service that provides the group communication. The service identification information may be identification information for identifying such a service.

The group identification information may be the information for identifying the group when the two or more communication terminals constitute the group and perform the communication among groups. Furthermore, in the case where the multiple items of content are delivered to the group, the group identification information may be the information for identifying these items of content.

For example, the group identification information may be the information for identifying the terminal group when the simulcast call is made among the multiple communication terminals. Furthermore, the group identification information may be the information for identifying the message for the telephone call. Alternatively, the group identification information may be the identification information for identifying the terminals to which the video is distributed when the video distribution is performed on the multiple communication terminals, as the group, and may be the identification information for identifying the distribution image in the case where the multiple videos are present.

The group identification information may be the IP multicast address, and may be the Temporary Mobile Subscriber Identify (TMSI) that is the temporary ID which is allocated by the telecommunications carrier and which is used for the user authentication. Without being limited to this, the group identification information may be the information for identifying the group, such as the mail address.

The application identification information is the identification information for identifying the application that is used in the ProSe service in which the UE establishes the direct communication path between the UE itself and the UE-R 15 or different UE.

The application user identification information may be the identification information for identifying the user or the UE in the application that is identified with the application identification information.

The ProSe Server 90 receives the service registration request message, determines whether the service that is provided to the UE-R 15 is approved or is disapproved, transmitted a service registration response as the response message, and notifies a result of determining whether to approve the service or to disapprove it, in a state where a flag for notifying the result is included in a service response registration response (S904). Additionally, along with disapproval information, the information for identifying the UE 10, the access point name (APN), the service identification information, the group identification information, the ProSe code, and the like may be included in the service response registration response.

The ProSe code may be the information that is transmitted when the UE 10 announces to the UE-R 15 or the different UE that is located nearby that the UE 10 itself is located near the UE-R 15 or the different UE. Additionally, the ProSe code may be the information that is received when the UE-R 15 or the different UE that is located nearby performs the monitoring to know if the UE-R 15 itself or the different UE itself is located near the UE 10. The ProSe code may be constituted by combining the application identification information, the information for identifying the UE, and the identification information for identifying the operator network such as the PLMN. Additionally, the information for identifying the UE may be the subscriber identification information, such as the IMSI, and may be the identification information, such as the TEID, that is temporarily allocated and that is acquired from the core network and is retained. Furthermore, the information for identifying the UE may be the application user identification information or the like.

In this manner, based on information in the service registration request message of the UE-R 15, the ProSe Server 90 may allocate the ProSe code and notifies the UE-R 15 of the allocated ProSe code.

The service registration procedure that is executed by the UE-R 15 is described above, but in the UE 10, the service registration procedure may also be performed using the same method as that which has so far been performed by the UE-R 15.

[1.3.1.2 Modification Example of the Service Registration Procedure]

Furthermore, in a different method from the method that is described in the service registration procedure in 1.3.1.1, the UE-R 15 may transmit the service registration request message to the ProSe Server 90 without in advance retaining the service that can be provided by the UE-R 15 and without in advance retaining the service registration request message.

The UE-R 15 may ask the ProSe Server 90 for information on a service that is provided. Additionally, the ProSe Server 90 may notify the service that is provided by the UE-R 15.

Because information elements for and transmission and reception techniques for the transmission and reception of the service registration request message and the transmission and reception of the service registration response message are the same as described in the service registration procedure in 1.3.1.1, detailed descriptions thereof are omitted.

Additionally, in the service registration procedure that is described in 1.3.1.1, the UE-R 15 in advance retains the information for identifying the ProSe Server 90, and transmits the service request message directly to the ProSe Server 90, and the ProSe Server 90 transmits the service registration response to the UE-R 15. However, the service registration request is not limited to this, and may be made through the MME 30.

For example, the UE-R 15 may transmit the service registration request message to the MME 30, and the MME 30 may transmit the service registration request message. Additionally, the MME 30 may acquire the information for identifying the ProSe Server 90, and may transmit the service registration request message to the ProSe Server 90.

A method of acquiring the information for identifying the ProSe Server 90, which is allocated in advance by the communications carrier, may be stored. Furthermore, the HSS 60 or the like may retain the information for identifying the ProSe Server 90, as the subscriber information, in a state of being associated with the UE-R15, and the MME 30 may make an inquiry by transmitting control message that includes the information for identifying the UE-R 15, to the HSS 60, and may acquire the information for identifying the ProSe Server 90 as a response to the inquiry.

Additionally, the ProSe Server 90 may transmit the message registration response message to the MME 30, and the MME 30 may receive the service registration response message. Based on the received service registration response message, the MME 30 may transmit the service registration response message to the UE-R 15.

Here, pieces of information that are included in the service registration request message and the service registration response message may be the same as those in the service registration request message and the service registration response message in the registration procedure in 1.3.1.1.

Alternatively, the information, such as the service identification information or the ProSe code, that is allocated or generated by the ProSe Server 90 in the registration procedure that is described in 1.3.1.1 may be allocated or generated by the MME 30 and the allocated or generated information may be notified to the UE-R 15 in a state of being included in the service registration response.

The service registration procedure that is executed by the UE-R 15 is described above, but in the same method as the method that has so far performed by the UE-R 15, the service registration procedure may be executed in the UE 10.

[1.3.2 Communication Path Establishment Processing by UE-R]

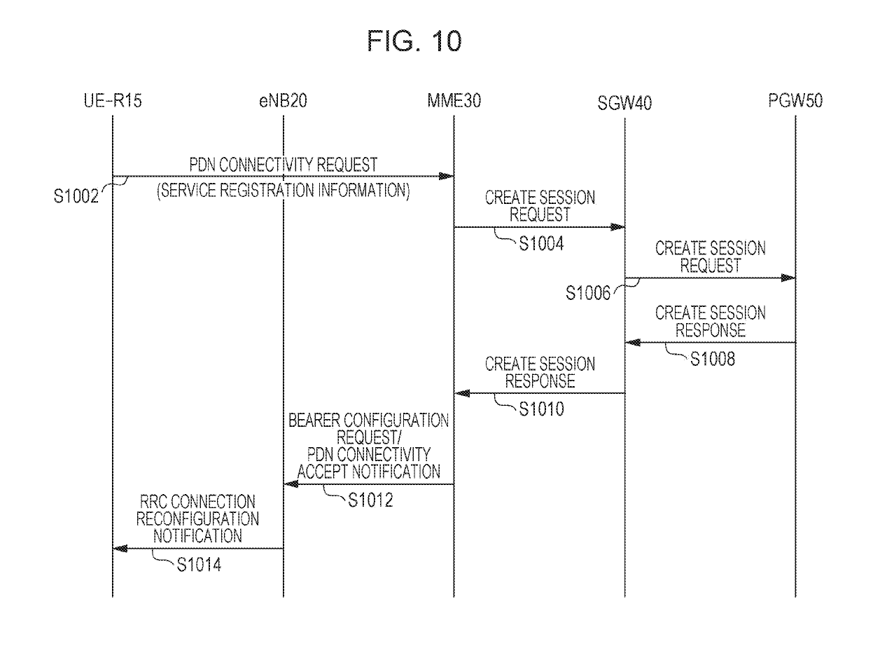

One example of the communication path establishment processing (S708) by the UR-R, which is described in the UE connection procedure in 1.3.1 referring to FIG. 7 is described referring to FIG. 10.

After the service is detected, the UE-R may select the PGW 50 according to the service, may execute the UE-R communication path establishment processing, and may request the establishment of the communication path between the UE-R itself and the PGW 50.

The UE-R 15 transmits the PDN connectivity request to the MME 30, and requests establishment of the PDN connection (S1002).

Included in the PDN connectivity request may be the information for identifying the UE-R 15, such as the International Mobile Subscriber Identity (IMSI), the APN, the service identification information, the group identification information, and the like.

The service identification information is the information for identifying the service that is provided by the mobile telecommunications carrier using the IP mobile communication network 5. The service identification information may be the APN, and may be the service domain identification information such as the Fully Qualified Domain Name (FQDN). Without being limited to this, the service identification information may be identification information that is associated with a service. Additionally, the service may be the voice call service that is based on the IMS, the video distribution service, or the like, and may be the service that provides the group communication. The service identification information may be identification information for identifying such a service.

The group identification information may be the information for identifying the group when the two or more communication terminals constitute the group and perform the communication among groups. Furthermore, in the case where the multiple items of content are delivered to the group, the group identification information may be the information for identifying these items of content.

For example, the group identification information may be the information for identifying the terminal group when the simulcast call is made among the multiple communication terminals. Furthermore, the group identification information may be the information for identifying the message for the telephone call. Alternatively, the group identification information may be the identification information for identifying the terminals to which the video is distributed when the video distribution is performed on the multiple communication terminals, as the group, and may be the identification information for identifying the distribution image in the case where the multiple videos are present.

The group identification information may be the IP multicast address, and may be the Temporary Mobile Subscriber Identify (TMSI) that is the temporary ID which is allocated by the telecommunications carrier and which is used for the user authentication. Without being limited to this, the group identification information may be information for identifying a group, such as a mail address.

Furthermore, the UE-R 15 may receive the broadcast information from the eNB 20 and based on the received broadcast information, may transmit the PDN connectivity request. For example, the eNB 20 may transmit the broadcast information including the APN, the service identification information, the group identification information, and the like, which are described above, and the UE-R 15 may receive the APN, the service identification information, and the group identification information from the broadcast information, and may include the received pieces of information in the PDN connectivity request. In this manner, the service or the information relating to the group communication, which can be provided by the UE-R 15, may be acquired from the broadcast information. Furthermore, the UE-R 15 may in advance retain such pieces of information.

In this manner, the UE-R 15 may establish the communication path that corresponds to the service that is provided to the terminal device which makes a connection the UE-R 15, or that corresponds to the group communication.

The MME 30 may receive the PDN connectivity request and may store the information for identifying the UE-R 15, such as the International Mobile Subscriber Identity (IMSI), the APN, the service identification information, and the group identification information.

Furthermore, the MME 30 may store the information for identifying the ProSe Server 90. The information for identifying the ProSe Server 90 may be retained in advance by an administrator or other persons, by performing in advance an operation such as a setting. Furthermore, the information for identifying the ProSe Server 90 may be retained by the UE-R 15 and may be transmitted in a state of being included in the PDN connectivity request. The MME 30 may store the information for identifying the ProSe Server 90 that is included in the PDN connectivity request.

Additionally, the MME 30 may store the information for identifying the UE-R 15 and the information for identifying the ProSe Server 90, in a state of being associated with each other. The MME 30 receives the PDN connectivity request, and determines whether or not to provide the service to the UE-R 15.

In a case where the service is approved, the MME 30 transmits a create session request to the SGW 40 (S1004). Additionally, the MME 30 may select the SGW 40 and the PGW 50.

Additionally, the SGW 40 receives the create session request from the MME 30, and, following the reception, transmits the create session request to the PGW 50 (S1006). Here, the SGW 40 may acquire the PGW 50 that is selected by the MME 30, and may determine the PGW 50 that is a transmission destination.

The PGW 50 receives the create session request from the SGW 40, and transmits a create session response to the SGW 40 (S1008). Here, the PGW 50 may allocate the bearer ID, the PDN connection ID, the TEID, and the IP address that is notified to the UE-R 15, and may include the allocated IDs in the create session response.

The SGW 40 may receive a session response from the PGW 50, and may transmit the create session response to the MME 30 (S1010). The SGW 40 may include the bearer ID, the PDN connection ID, the TEID, and the IP address that is notified to the UE-R 15, which are received, in the create session response. Furthermore, the bearer ID, the PDN connection ID and the TED may be allocated by the SGW 40, and the allocated ID and the TEIDs may be transmitted in a state of being included in the create session response.

The MME 30 may receive the create session response from the SGW 40, and may transmit a bearer configuration request/PDN connectivity accept notification to the eNB 20 (S1012). The bearer ID, the PDN connection ID, the TEID, and the IP address that is notified to the UE-R 15 may be included in the bearer configuration request/PDN connectivity accept notification.

Here, based on the information that is included in the create session response, the MME 30 may generate the MME communication path context 442 that is associated with the PDN connection which is established between the UE-R 15 and the PGW 50.

The APN, the bearer ID, the PDN connection ID, and the TED may be acquired from the create session response and the acquired IDs may be retained. Furthermore, the allocation may be performed by the MME 30.

Furthermore, for the base station identification information, information on the eNB 20 to which the UE-R 15 makes a connection may be acquired and the acquired information may be retained. Furthermore, for the service identification information, and the group identification information, the information that is transmitted by the UE-R 15 in a state of being included in the PDN connectivity request may be acquired, and the acquired information may be retained.

The eNB 20 may receive the bearer configuration request/PN connection approval notification, and may transmit an RRC connection reconfiguration notification to the UE-R 15 (S1014).

Here, based on the information that is included in the received control information, the eNB 20 may generate an eNB communication path context 242 that is associated with the PDN connection which is established between the UE-R 15 and the PGW 50.

The APN, the bearer ID, the PDN connection ID, and the TEID may be acquired from the bearer configuration request/PN connection approval notification, and the acquired IDs may be retained. Furthermore, without being limited to this, the eNB 20 may perform the allocation and the retention.

Furthermore, for the base station identification information, the information for identifying the eNB 20 itself may be retained. Furthermore, for the service identification information, and the group identification information, the information that is transmitted by the UE-R 15 in a state of being included in the PDN connectivity request may be acquired, and the acquired information may be retained. When it comes to acquisition means, the pieces of information described above may be acquired using the control information from the UE-R 15 or may be acquired from the MME 30. Furthermore, the service identification information and the group identification information may be managed in the ProSe Server 90 in a state of being associated with the UE-R 15, and, the eNB 20, for example, may make an inquiry to the ProSe 90 or may receive a notification, thereby acquiring the service identification information and the group identification information. Moreover, the bearer ID, the PDN connection ID, the TEID, and the IP address that is notified to the UE-R 15, which are described above, may be included in an RRC connection configuration notification.

The UE-R 15 receives the RRC connection reconfiguration notification, and completes the establishment of the PDN connection. The UE-R 15 can perform the communication that involves the PDN connection, using the acquired IP address.

Here, based on the information that is included in the received control information, the UE-R 15 may generate a UE-R communication path context 1542 that is associated with the PDN connection which is established between the UE-R 15 and the PGW 50.

The APN, the bearer ID, the PDN connection ID, and the TED may be acquired from the RRC connection reconfiguration notification, and the acquired IDs may be retained. Furthermore, without being limited to this, the IDs described above may be retained based on the information that is included in the PDN connectivity request, such as one that is retained in advance by the UE-R 15.

Furthermore, for the base station identification information, the information for identifying the eNB 20 to which the UE-R 15 makes a connection may be retained.

Furthermore, for the service identification information, and the group identification information, the information that is transmitted by the UE-R 15 in a state of being included in the PDN connectivity request may be retained. When it comes to the acquisition means, the pieces of information described above may be acquired using the control information from the eNB 20 or may be acquired from the MME 30. Furthermore, the information for identifying the service of which the provision the ProSe Server 90 and the group identification information may be managed in the ProSe Server 90, and the UE-R 15, for example, may make an inquiry to the ProSe 90 or may receive a notification, thereby acquiring the service identification information and the group identification information.

Furthermore, the UE-R 15 may receive the RRC connection reconfiguration notification in which MME identification information is further included, and may store the MME identification information.

As described above, the UE-R 15 can establish the PDN connection between the UE-R 15 itself and the PGW 50.

Furthermore, the UE-R 15 may acquire the service information and the group information that are associated with the PDN connection, from the ProSer Server 90. The ProSe Server 90 may acquire information in an MME communication path context from the MME 30 or the like, and may generate and may retain the ProSe Server communication path context 942.

Without being limited to this, following the establishment of the PDN connection, the UE-R 15 may notify the ProSer Server 90 of the generated UR-R communication path context. The ProSe Server 90 may generate the ProSe Server communication path context 942 based on the received information and may retain the generated ProSe Server communication path context 942.

[1.3.3 UE Communication Path Establishment Processing]

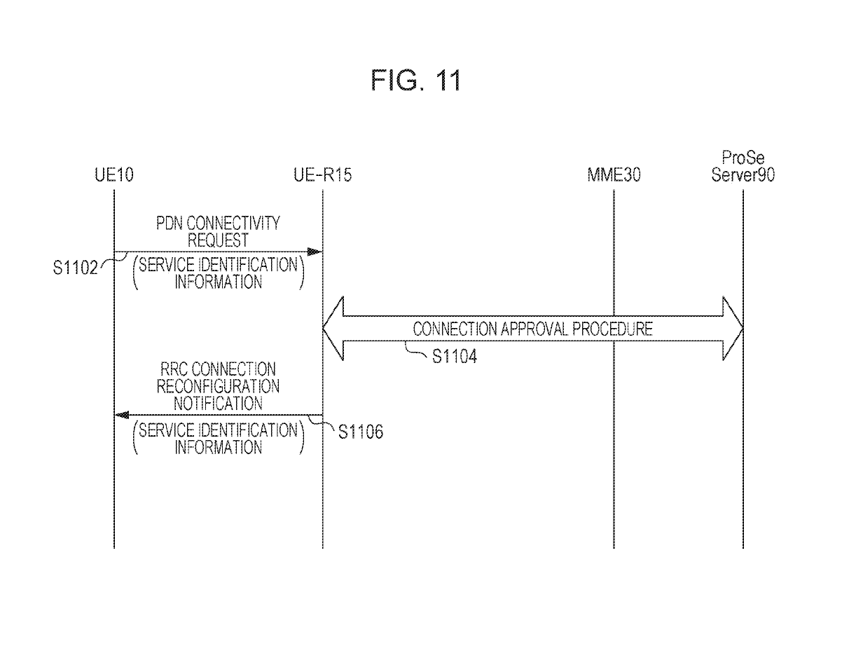

One example of the UE communication path establishment processing (S714) in the UE connection procedure in 1.3.1, which is described referring to FIG. 7, is described referring to FIG. 11.

The UE 10 may transmit the PDN connectivity request to the UE-R 15 and may request the establishment of the communication path (S1102).

Included in the PDN connectivity request may be the information for identifying the UE 10, such as the International Mobile Subscriber Identity (IMSI), the APN, the service identification information, the group identification information, and the like.

The service identification information is the information for identifying the service that is provided by the mobile telecommunications carrier using the IP mobile communication network 5. The service identification information may be the APN, and may be the service domain identification information such as the Fully Qualified Domain Name (FQDN). Without being limited to this, the service identification information may be identification information that is associated with a service. Additionally, the service may be the voice call service that is based on the IMS, the video distribution service, or the like, and may be the service that provides the group communication. The service identification information may be the identification information for identifying such a service.

The group identification information may be the information for identifying the group when the two or more communication terminals constitute the group and perform the communication among groups. Furthermore, in the case where the multiple items of content are delivered to the group, the group identification information may be the information for identifying these items of content.

For example, the group identification information may be the information for identifying the terminal group when the simulcast call is made among the multiple communication terminals. Furthermore, the group identification information may be the information for identifying the message for the telephone call. Alternatively, the group identification information may be the identification information for identifying the terminals to which the video is distributed when the video distribution is performed on the multiple communication terminals, as the group, and may be the identification information for identifying the distribution image in the case where the multiple videos are present.

The group identification information may be the IP multicast address, and may be the Temporary Mobile Subscriber Identify (TMSI) that is the temporary ID which is allocated by the telecommunications carrier and which is used for the user authentication. Without being limited to this, the group identification information may be information for identifying a group, such as a mail address.

Furthermore, the UE 10 may receive the broadcast information from the UE-R 15 and based on the received broadcast information, may transmit the PDN connectivity request. For example, the UE-R 15 may transmit the broadcast information including the APN, the service identification information, the group identification information, and the like, which are described above, and the UE 10 may receive the APN, the service identification information, and the group identification information from the broadcast information, and may include the received pieces of information in the PDN connectivity request. In this manner, the service or the information relating to the group communication, which can be provided by the UE 10, may be acquired from the broadcast information. Furthermore, the UE-R 15 may in advance retain such pieces of information, and may include them in the PDN connectivity request.

The UE-R 15 receives the PDN connectivity request, and executes a connection approval procedure (S1104). In the connection approval procedure, the UE-R communication path context 1542 that corresponds to the service information, the APN, the information for identifying the group communication, which are included in the PDN connectivity request, may be selected and the PDN connection that is associated with the UE-R communication path context 1542 may be selected.

The UE-R 15 may perform data transfer, with the selected PDN connection as a transfer path for the transmission and reception of data between the UE 10 and the PDN.

Additionally, the UE-R 15 may notify the MME 30 of information in the UE-R communication path context 1542 that corresponds to the selected PDN connection, and may register the service that is provided to the UE 10 and information on the communication path. Additionally, the MME 30 may retain the received information in the MME communication path context 342.

Additionally, the UE-R 15 may notify the ProSe Server 90 of the information in the UE-R communication path context 1542 that corresponds to the selected PDN connection, and may register the service that is provided to the UE 10 and the information on the communication path. Additionally, the ProSe Server 90 may retain the received information in the ProSe Server communication path context 942.

In this manner, the UE-R 15 may establish the connectivity between the UE 10 and the PDN. Additionally, the UE-R 15 may transmit a response to the PDN connectivity request to the UE 10 (S1106). Here, a response control message may be an RR connection reconfiguration notification.

Furthermore, without registering with the MME 30 or the ProSe Server 90, the UE-R 15 may make an inquiry and may acquire information element in the UE-R communication path context information 1542.

The UE-R 15 may transmit an information request message to the MME 30, and the MME 30 may transmit information that includes the service identification information, the information for identifying the group communication, and the like, which are provided to the UE-R 15.

Furthermore, the UE-R 15 may transmit the information request message to the ProSe Server 90, and the ProSe Server 90 may transmit the information that includes the service identification information, the information for identifying the group communication, and the like, which are provided to the UE-R 15.

Moreover, the bearer ID, the PDN connection ID, the TEID, and the IP address that is notified to the UE-R 15 may be included in the response message.

For the bearer ID, the PDN connection ID, the TED, and the IP address, the information that is included in the UE-R communication path context 1542 may be used, and the UE-R 15 may perform new allocation and may give a notification.

The UE 10 receives the response to the PDN connectivity request, and establishes a bearer between the UE 10 itself and the UE-R 15. The connectivity to the PDN may be established by performing mapping on the PDN connection that is established by the UE-R 15 between the UE-R 15 itself and the PGW 50 and the bearer that is established between the UE-R 15 and the UE 10. The UE 10 can perform the transmission and reception of data between the UE 10 itself and the PDN using the IP address that is acquired with the response to the PDN connectivity request.

Furthermore, following the reception of the response, the UE 10 may generate the UE communication path context 142. The UE 10 may generate the UE communication path context 142 based on the data that is received with the response to the PDN connectivity request.

Additionally, the UE 10 may notify the MME 30 of information in the UE communication path context 142 that corresponds to the selected PDN connection, and may register the service that is provided to the UE 10 and information on the communication path. Additionally, the MME 30 may retain the received information in the MME communication path context 342.

Additionally, the UE 10 may notify the ProSe Server 90 of information in the UE communication path context 1142 that corresponds to the selected PDN connection, and may register the service that is provided to the UE 10 and information on the communication path. Additionally, the ProSe Server 90 may retain the received information in the ProSe Server communication path context 942.

Furthermore, without the UE 10 registering with the MME 30 or the ProSe Server 90, the UE-R 15 may make an inquiry and may acquire information element that is registered in the UE communication path context information 142.

The UE 10 may transmit the information request message to the MME 30, and the MME 30 may transmit information that includes the service identification information, the information for identifying the group communication, and the like, which are provided to the UE 10.

Furthermore, the UE 10 may transmit the information request message to the ProSe Server 90, and the ProSe Server 90 may transmit the information that includes the service identification information, the information for identifying the group communication, and the like, which are provided to the UE 10.

[1.3.3.1 Modification Example of UE Communication Path Establishment Processing]

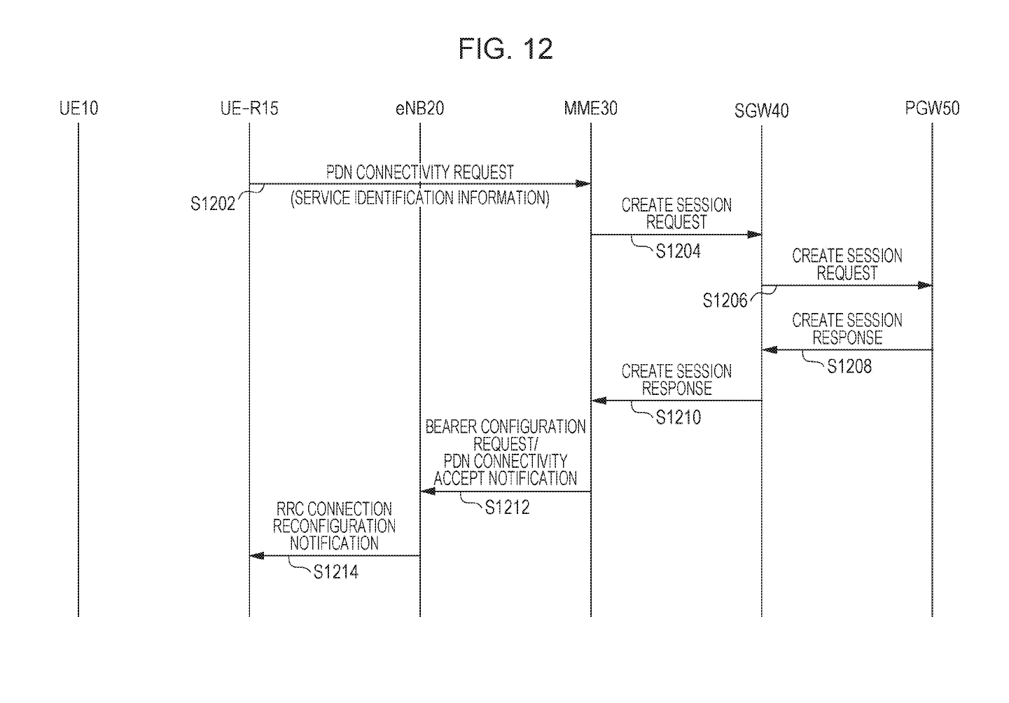

Furthermore, a modification example of the connection approval procedure (S1104) in the communication path establishment processing in 1.3.3, which is described referring to FIG. 11 is described referring to FIG. 12.

Following reception of the PDN connectivity request, the UE-R 15 may establish new PDN connection.

The UE-R 15 transmits the PDN connectivity request to the MME 30, and requests the establishment of the PDN connection (S1202).

Included in the PDN connectivity request may be the pieces of information for identifying the UE-R 15 and the UE 10, such as the International Mobile Subscriber Identity (IMSI), the APN, the service identification information, the group identification information, and the like.

The service identification information is the information for identifying the service that is provided by the mobile telecommunications carrier using the IP mobile communication network 5. The service identification information may be the APN, and may be the service domain identification information such as the Fully Qualified Domain Name (FQDN). Without being limited to this, the service identification information may be identification information that is associated with a service. Additionally, the service may be the voice call service that is based on the IMS, the video distribution service, or the like, and may be the service that provides the group communication. The service identification information may be the identification information for identifying such a service.

The group identification information may be the information for identifying the group when the two or more communication terminals constitute the group and perform the communication among groups. Furthermore, in the case where the multiple items of content are delivered to the group, the group identification information may be the information for identifying these items of content.

For example, the group identification information may be the information for identifying the terminal group when the simulcast call is made among the multiple communication terminals. Furthermore, the group identification information may be the information for identifying the message for the telephone call. Alternatively, the group identification information may be the identification information for identifying the terminals to which the video is distributed when the video distribution is performed on the multiple communication terminals, as the group, and may be the identification information for identifying the distribution image in the case where the multiple videos are present.

The group identification information may be the IP multicast address, and may be the Temporary Mobile Subscriber Identify (TMSI) that is the temporary ID which is allocated by the telecommunications carrier and which is used for the user authentication. Without being limited to this, the group identification information may be information for identifying a group, such as a mail address.

Furthermore, the UE-R 15 may receive the broadcast information from the eNB 20 and based on the received broadcast information, may transmit the PDN connectivity request. For example, the eNB 20 may transmit the broadcast information including the APN, the service identification information, the group identification information, and the like, which are described above, and the UE-R 15 may receive the APN, the service identification information, and the group identification information from the broadcast information, and may include the received pieces of information in the PDN connectivity request. In this manner, the service or the information relating to the group communication, which can be provided by the UE-R 15, may be acquired from the broadcast information. Furthermore, the UE-R 15 may in advance retain the pieces of information described.

In this manner, the UE-R 15 may establish the communication path that corresponds to the service that is provided to the terminal device which makes a connection the UE-R 15, or that corresponds to the group communication.

The MME 30 receives the PDN connectivity request, and determines whether or not to provide the service to the UE-R 15.

In a case where the service is approved, the MME 30 transmits the create session request to the SGW 40 (S1204). Additionally, the MME 30 may select the SGW 40 and the PGW 50.

Additionally, the SGW 40 receives the create session request from the MME 30, and, following the reception, transmits the create session request to the PGW 50 (S1206). Here, the SGW 40 may acquire the PGW 50 that is selected by the MME 30, and may determine the PGW 50 that is the transmission destination.

The PGW 50 receives the create session request from the SGW 40, and transmits the create session response to the SGW 40 (S1208). Here, the PGW 50 may allocate the bearer ID, the PDN connection ID, the TEID, and the IP address that is notified to the UE-R 15, and may include the allocated IDs in the create session response.

The SGW 40 may receive the session response from the PGW 50, and may transmit the create session response to the MME 30 (S1210). The SGW 40 may include the bearer ID, the PDN connection ID, the TEID, and the IP address that is notified to the UE-R 15, which are received, in the create session response. Furthermore, the bearer ID, the PDN connection ID and the TED may be allocated by the SGW 40, and the allocated IDs may be transmitted in a state of being included in the create session response.

The MME 30 may receive the create session response from the SGW 40, and may transmit a bearer configuration request/PDN connectivity accept notification to the eNB 20 (S1212). The bearer ID, the PDN connection ID, the TEID, and the IP address that is notified to the UE-R 15 may be included in the bearer configuration request/PDN connectivity accept notification.

Here, based on the information that is included in the create session response, the MME 30 may generate the MME communication path context 442 that is associated with the PDN connection which is established between the UE-R 15 and the PGW 50.

The APN, the bearer ID, the PDN connection ID, and the TED may be acquired from the create session response and the acquired IDs may be retained. Furthermore, the allocation may be performed by the MME 30.

Furthermore, for the base station identification information, information on the eNB 20 to which the UE-R 15 makes a connection may be acquired and the acquired information may be retained.

Furthermore, for the service identification information, and the group identification information, the information that is transmitted by the UE-R 15 in a state of being included in the PDN connectivity request may be acquired, and the acquired information may be retained.

The eNB 20 may receive the bearer configuration request/PN connection approval notification, and may transmit the RRC connection reconfiguration notification to the UE-R 15 (S1214).

Here, based on the information that is included in the received control information, the eNB 20 may generate the eNB communication path context 242 that is associated with the PDN connection which is established between the UE-R 15 and the PGW 50.

The APN, the bearer ID, the PDN connection ID, and the TED may be acquired from the bearer configuration request/PN connection approval notification, and may be retained. Furthermore, without being limited to this, the eNB 20 may perform the allocation and the retention.

Furthermore, for the base station identification information, the information for identifying the eNB 20 itself may be retained. Furthermore, for the service identification information, and the group identification information, the information that is transmitted by the UE-R 15 in a state of being included in the PDN connectivity request may be acquired, and the acquired information may be retained. When it comes to the acquisition means, the pieces of information described above may be acquired using the control information from the UE-R 15 or may be acquired from the MME 30.

Furthermore, the service identification information and the group identification information may be managed in the ProSe Server 90 in the state of being associated with the UE-R 15, and, the eNB 20, for example, may make an inquiry to the ProSe 90 or may receive a notification, thereby acquiring the service identification information and the group identification information. Moreover, the bearer ID, the PDN connection ID, the TED, and the IP address that is notified to the UE-R 15, which are described above, may be included in the RRC connection configuration notification.

The UE-R 15 receives the RRC connection reconfiguration notification, and completes the establishment of the PDN connection. The UE-R 15 can perform the communication that involves the PDN connection, using the acquired IP address.

Here, based on the information that is included in the received control information, the UE-R 15 may generate the UE-R communication path context 1542 that is associated with the PDN connection which is established between the UE-R 15 and the PGW 50.

The APN, the bearer ID, the PDN connection ID, and the TED may be acquired from the RRC connection reconfiguration notification, and the acquired IDs may be retained. Furthermore, without being limited to this, the IDs described above may be retained based on the information that is included in the PDN connectivity request, such as one that is retained in advance by the UE-R 15.

Furthermore, for the base station identification information, the information for identifying the eNB 20 to which the UE-R 15 makes a connection may be retained.

Furthermore, for the service identification information, and the group identification information, the information that is transmitted by the UE-R 15 in a state of being included in the PDN connectivity request may be retained. When it comes to the acquisition means, the pieces of information described above may be acquired using the control information from the eNB 20 or may be acquired from the MME 30. Furthermore, the information for identifying the service of which the provision is approved and the group identification information may be managed in the ProSe Server 90, and the UE-R 15, for example, may make an inquiry to the ProSe 90 or may receive a notification, thereby acquiring the service identification information and the group identification information.

As described above, the UE-R 15 can establish the PDN connection between the UE-R 15 itself and the PGW 50.

Furthermore, the UE-R 15 may acquire the service information and the group information that are associated with the PDN connection, from the ProSer Server 90. The ProSe Server 90 may acquire information in an MME communication path context from the MME 30 or the like, and may generate and may retain the ProSe Server communication path context 942.

Without being limited to this, following the establishment of the PDN connection, the UE-R 15 may notify the ProSer Server 90 of the generated UR-R communication path context. The ProSe Server 90 may generate the ProSe Server communication path context 942 based on the received information and may retain the generated ProSe Server communication path context 942.

Thereafter, in the same method as is described in the UE communication path establishment processing in 1.3.3, the response to the PDN connectivity request that is transmitted by the UE 10 may be transmitted to the UE 10.

[1.3.4 Modification Example of the UE Connection Procedure]

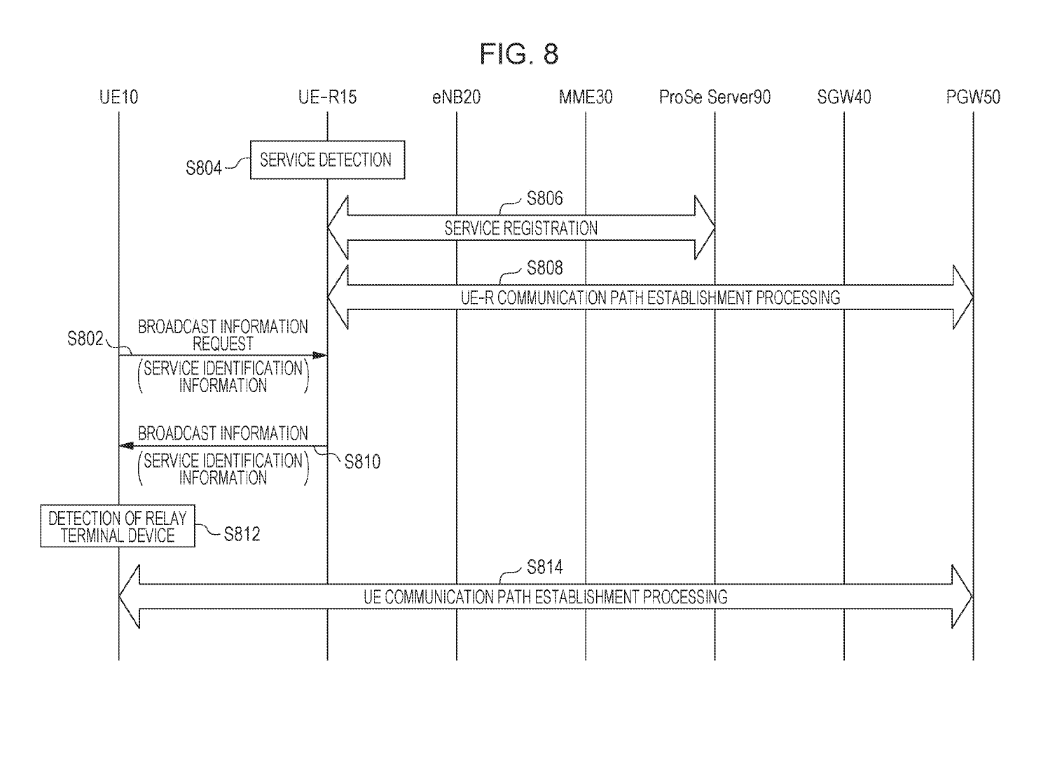

In the UE connection procedure that is described in 1.3.1, when the broadcast information request is received from the UE 10, the UE-R 15 is caused to perform the service detection and execute the service registration procedure, but this does not necessarily impose any limitation. As illustrated in FIG. 8, the service registration may be started without receiving the broadcast information request of the UE 10.

For example, service detection processing (S804) may be started without receiving the broadcast information request. The triggering of the start of the processing may be through a user operation that is performed by a user of the UE-R 15 using an application or a terminal setting, and may be programmed in advance in such a manner that the processing is started at the time of the activation.

Additionally, based on a result of the service detection processing, the service registration processing (S806) and the UE-R communication path establishment processing (S808) may be performed. Because details of such processing that is based on the result of the service detection processing is the same as those of the processing that are described in the UE connection procedure in 1.3.1 referring to FIG. 7, a detailed description of the processing is omitted.

Furthermore, in service registration (S806), because the UE-R 15 does not acquire the information for identifying the UE 10, the service identification information indicating a service that is provided by the UE-R and the group identification information may be registered with the ProSe Server 90.

In this manner, before the broadcast information request is received from the UE 10, the UE-R 15 may in advance register a service that can be provided and may establish the communication path between the UE-R 15 itself and the PGW 50.

The UE 10 may transmit the broadcast information request in a state where the communication path described above is already established by the UE-R 15 (S802).

The UE-R 15 may receive the broadcast information request that is transmitted by the UE 10 and based on the broadcast information request, may transmit the broadcast information (S810). Furthermore, without receiving the broadcast information request, based on the completion of the service registration or the UE-R communication path establishment processing, the UE-r may transmit the broadcast information and may be concerned about a service that can be provided to a neighboring terminal. The UE 10 may receive the broadcast information and may detection of the relay terminal device (S812), and the UE communication path establishment processing (S814).

Service detection (S804), service registration (S806), UE-R communication path establishment processing (S808), transmission and reception of the broadcast information request (S802), transmission and reception of the broadcast information (S810), detection of the relay terminal device (S812), and UE communication path establishment processing (S814) in the procedure are different, only in terms of events that trigger starting of processing operations, from the service detection (S704), the service registration (S706), the UE-R communication path establishment processing (S708), the transmission and reception of the broadcast information request (S702), the transmission and reception of the broadcast information (S710), the detection of the relay terminal device (S712), and the UE communication path establishment processing (S714), respectively, which are described in the UE connection procedure in 1.3.1 in referring to FIG. 7. Because of this, the processing operations may be performed in the same manner as those described referring to FIG. 7, and detailed descriptions thereof are omitted.

[1.3.5 Tracking Area Update Procedure]

Next, a tracking area update procedure that is executed when the UE-R 15 is in a state of an idle mode.

The state of the idle mode is a state in where, in a case were the UE-R 15 does not perform the transmission and reception of data for a fixed time or more while using the communication path that the UE-R 15 establishes by making a connection to the PDN 80 through the eNB 20 and the core network 7, the wireless connection between the access network such as the LTE AN 15 and the UE-R 15 is released.

More specifically, in a case where the transmission and reception of data that use the PDN network which is established between the UE-R 15 and the PGW 50 is not performed for a fixed time or more, the UE-R 15, the eNB 20, or an apparatus that is constituted to be in the core network 7 initiatively releases the radio bearer between the UE-R 15 and the eNB 20 is released. In the release of the radio bearer, information that is associated with the radio bearer, such as the radio bearer ID, and that is retained by each of the UE-R 15 and the eNB 20 is deleted, or a radio resource, such as a frequency is released.

In this manner, the UE-R15 transitions to the state of the idle mode, and this releases a radio resource that is not used throughout the communication system as a whole. Thus, a limited radio resource can be used efficiently in such a manner that different UE and the like can use the released radio source.

The tracking area update procedure is executed to know a location of the UE-R 15 in such an idle mode. Because the UE-R 15 releases the radio bearer between the UE-R 15 itself and the eNB 20 and the connectivity at the radio level is not present, following the movement of the UE-R 15, the apparatus that is constituted to be in the core network 7 such as the MME 30 has the difficulty in knowing which the eNB 20 the UE-R 15 is located near.

Accordingly, in the state of the idle mode, by using a timer that is configured in advance, and so forth, the UE-R 15 periodically executes the tracking area update procedure and notifies which base station device the UE-R 15 can make a connection to. Furthermore, as far as the MME 30, the SGW 40, or the apparatus that is constituted to be in the core network 7 such as the PGW 50, is concerned, which base station device the UE-R 15 in the idle mode is located near or which base station device the UE-R 15 makes a connection to can be detected.

Here, in the MME 30, the connectivity to multiple base station device groups that includes the eNB 20 is established, and an area called a tracking area is constituted. For example, the MME 30 can manage a base station group that is constituted to be within an area near which a physical location is, and can constitute such an area, as the tracking area. Furthermore, regardless of whether or not the physical location is nearby, the base station group that is associated with the tracking area can be constituted, for example, by selecting and constituting the base station that the communications carrier wants to manage in a distinguished manner in terms of operation. More precisely, with the MME 30 being associated with the MME 30, multiple base stations can be managed and the tracking area can be constituted.

In this manner, the terminal device in the idle state makes a request to the base station that constitutes the cell, for the registration with the tracking area, and in the position management device, the terminal device is registered with the tracking area and which tracking area the terminal device is located at is managed. Additionally, the tracking area is managed with a tracking list, and the base station or the terminal device may be managed in a state of being associated with the tracking area. Moreover, the position management device can manage multiple tracking areas, and can retain multiple tracking area lists. Additionally, the terminal device may be managed in a state of being associated with each of the multiple tracking area that are managed by the same position management device.

Multiple position management devices may be constituted in the core network 7, separately from the MME 30. For example, the MME 30 and an MME-A 35 may be constituted in the core network 7. The MME-A 35 is different from the MME 30 in terms of the tracking area that is managed in the MME 30, and, except for this difference, has the same constitution as the MME 30. Accordingly, a repetitive description of the constitution of the MME-A 35 is omitted.

In a case where the UE-R 15 in the state of the idle mode executes the tracking area update procedure, in some cases, the UE-R 15 makes connections to different base stations before and after the transfer update procedure is executed due to the movement of the UE-R15. Additionally, in some cases, the position management devices that manage the base stations, respectively, are different position management devices. For example, the UE-R 15 moves from the base station device that is managed by the MME 30 to near the base station device that is managed by the MME-A 35, and executes the tracking area update procedure.

The tracking area update procedure in which the movement to the tracking area that is managed by different position management devices takes place as described above will be described below. The tracking area update procedure is a procedure in which the MME-A 35 detects that the UE-R 15 moves from the base station that is managed by the MME 30 to the base station that is managed by the MME-A 35. Furthermore, as far as the UE-R15 is concerned, this is a procedure for the movement from the tracking area that is managed by the MME 30 to the tracking area that is managed by the MME-A 35, and in the tracking area update procedure, reallocation (MME-Allocation) of the position management device is performed.

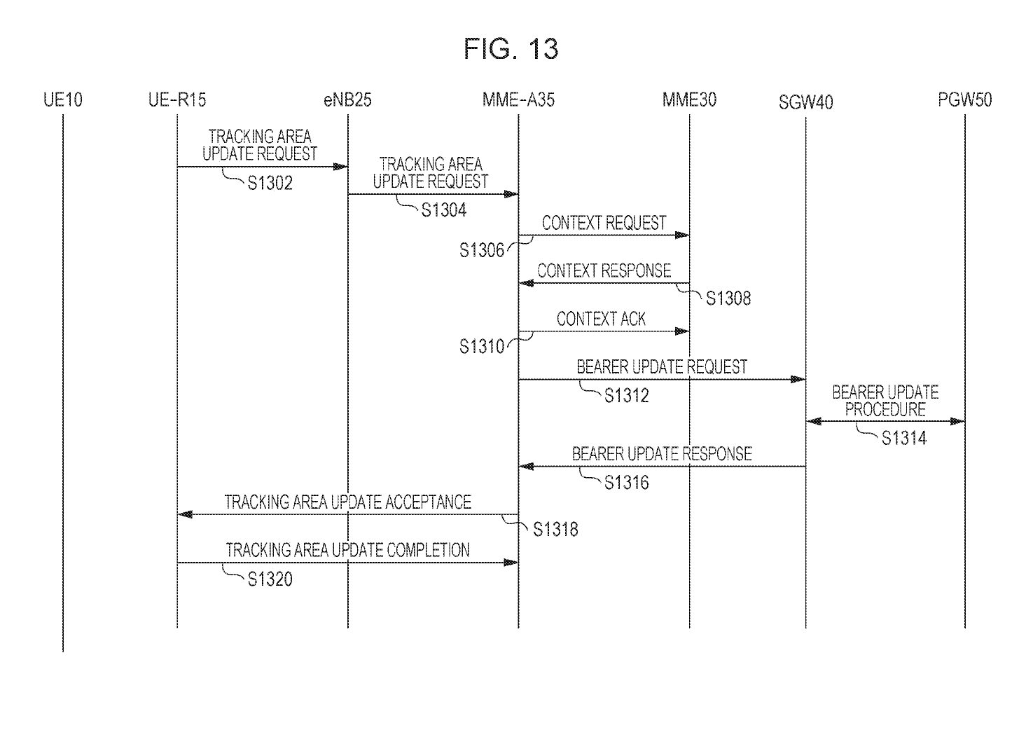

The tracking area update procedure that includes the reallocation of the position management device is described referring to FIG. 13.

First, an initial state of the tracking area update procedure that is initiatively executed by the UE-R 15 is described.

With the above-described procedure, the UE-R 15 makes a connection to the core network 7 through the eNB 20, and establishes the PDN connection between the UE-R 15 itself and the PGW 50. Additionally, the direct communication path between the UE-R 15 itself and the neighboring UE 10 is established. The UE-R 15 performs the transmission and reception of data using such a communication path.

Additionally, if the transmission and reception of data that use the PDN connection between the UE-R 15 itself and the PGW 50 are not performed for a fixed time or more, the radio bearer between the UE-R 15 and the eNB 20 is released and the transitioning to the idle mode takes place.

Here, the initial states that are present when the tracking area update procedure is executed are not limited to this, and may be arbitrary states that include a state in the related art, in which the UE-R 15 updates the tracking area. Additionally, a method in which the UE-R 15 establishes the PDN connection between the UR-R 15 and the PGW 50 or a method of establishing the direct communication path between the UE-R 15 itself and the UE 10 is not limited to the above-described method, and may be established with other methods. Furthermore, regardless of whether or not the state of the idle mode is present, the UE-R 15 may execute a tracking update procedure in an active mode.

The UE-R 15 transmits a tracking area update request message to the eNB25 (S1302). The information for identifying the UE-R 15, information for identifying the tracking area, information for identifying the position management device, ProSe capability information, the application identification information, the application user identification information, and the ProSe code may be transmitted in a state of being included in the message. The ProSe capability information may be capability information indicating that the direct communication path to the neighboring UE can be established and may be capability information indicating that the ProSe service can be enjoyed. Furthermore, the ProSe capability information may be information indicating that the ProSe service is enjoyed and may be information indicating that the direct communication path to the neighboring terminal is established, and these pieces of information may be included, as different pieces of identification information, in the message.

Furthermore, the information for identifying the position management device may include information for identifying the MME 30 that has so far performed the position management of the UE-R 15. Without being limited to these, information that is included in a tracking area update request message in the related art may be together included in the message as well.

The application identification information is the identification information for identifying the application that is used in the ProSe service in which the UE-R 15 establishes the direct communication path between the UE-R 15 itself and different UE.

The application user identification information may be the identification information for identifying the user or the UE-R 15 in the application that is identified with the application identification information.

The ProSe code may be the information that is transmitted when the UE announces to the different UE that is located nearby that the UE itself is located near the different UE. Additionally, the ProSe code may be the information that is received when the different UE that is located nearby performs the monitoring to know if the different UE itself is located near the UE. The ProSe code may be constituted by combining the application identification information, the information for identifying the UE, and the identification information for identifying the operator network such as the PLMN. Additionally, the information for identifying the UE may be the subscriber identification information, such as the IMSI, may be the identification information, such as the TEID, that is temporarily allocated, and may be the application user identification information or the like.

For the triggering of the transmission of the tracking area update request message by the UE-R 15, a transmission timing may be determined based on a timer that starts from a timing at which the UE-R 15 in the state of the idle mode transitions to the active mode. Furthermore, the UE-R 15 may in advance retain a timer that determines an interval at which the tracking area update request message is transmitted may be determined, and may determine a value of the timer.

The eNB 25 receives the tracking area update request message. The eNB 25 may be a base station device that has the connectivity to the MME-A 35, and may be a base station device that belongs to the tracking area that is managed by the MME-A 35. In other words, the eNB 25 is a base station device that is managed by the MME-A 35, and is a base station device that belongs to the tracking area that is constituted by the MME-A 35. Here, the eNB 25 may be a base station device that is different from the eNB 20 that is constituted to be in the LTE AN 9. Furthermore, the tracking area to which the eNB 25 belongs and the tracking area to which the eNB 20 belongs may be different tracking areas. Additionally, each of the tracking areas may be a tracking area that is managed by the MME 30. The tracking areas may be managed by different position management devices, such as when the tracking area to which the eNB 25 belong is managed by the MME-A 35, and when the tracking areas to which the eNB 20 belongs is managed by the MME 30. Furthermore, because a constitution of the eNB 25 may be the same as the constitution of the eNB 20 that is already described, a detailed description thereof is omitted.

Here, the UE-R 15 periodically executes the tracking area update procedure. When it comes to the tracking update procedure that is previously executed, the UE-R 15 may transmit the tracking area update request message to the eNB 20 and may execute the track area update procedure.

The eNB 20 may be a base station device that has the connectivity to the MME 30, and may be a base station device that belongs to the tracking area that is managed by the MME 30. In other words, the eNB 20 is a base station device that is managed by the MME 30, and is a base station device that belongs to the tracking area that is constituted by the MME 30.

More precisely, with the present tracking area update, the UE-R15 transmits the tracking area update request message to the base station device that is different from the base station which transmits the tracking area update request message earlier. Additionally, the base station that receives the tracking area update request message is a base station that is different from the preceding base station, and that is managed by the position management device.

Based on the reception of the tracking area update request from the UE-R 15, the eNB 25 may transmit the tracking area update request to the MME-A 35 (S1304). The information for identifying the UE-R 15, the information for identifying the tracking area, the information for identifying the position management device, the ProSe capability information, base station identification information for identifying the eNB 25, the application identification information, the application user identification information, and the ProSe code may be transmitted in the state of being included in the message. The ProSe capability information may be the capability information indicating that the direct communication path to the neighboring UE can be established and may be the capability information indicating that the ProSe service can be enjoyed. Furthermore, the ProSe capability information may be the information indicating that the ProSe service is enjoyed and may be the information indicating that the direct communication path to the neighboring terminal is established, and these pieces of information may be included, as the different pieces of identification information, in the message.

Furthermore, the information for identifying the position management device may include the information for identifying the MME 30 that has so far performed the position management of the UE-R 15. Without being limited to these, the information that is included in the tracking area update request message in the related art may be together included in the message.

The application identification information is the identification information for identifying the application that is used for the ProSe service in which the UE-R establishes the direct communication path between the UE-R itself and the different UE.

The application user identification information may be the identification information for identifying the user or the UE-R 15 in the application that is identified with the application identification information.

The ProSe code may be the information that is transmitted when the UE announces to the different UE that is located nearby that the UE itself is located near the different UE. Additionally, the ProSe code may be the information that is received when the different UE that is located nearby performs the monitoring to know if the different UE itself is located near the UE. The ProSe code may be constituted by combining the application identification information, the information for identifying the UE, and the identification information for identifying the operator network such as the PLMN. Additionally, the information for identifying the UE may be the subscriber identification information, such as the IMSI, may be the identification information, such as the TEID, that is temporarily allocated, and may be the application user identification information or the like.

Based on the reception of the tracking area update message that is transmitted from the eNB 25, the MME-A 35 may transmit a context request message to the MME 30 (S1306). With the transmission of such a context supply message, the MME-A 35 may initiatively perform the reallocation (MME-Allocation) of the position management device.

Based on the information that is included in the received tracking area update message, the MME-A 35 may select the position management device that transmits the context request message. For example, the tracking area information and the position management device may be managed in advance in a state of being associated with each other, the position management device that is associated with the received tracking area information may be selected, and it may be determined that the message is transmitted to the MME 30. Furthermore, the position management device may be selected with the information for identifying the position management device, which is included in the tracking area request message, and the message may be transmitted to the MME 30.

The information for identifying the UE-R 15, the information for identifying the tracking area, the information for identifying the position management device, the ProSe capability information, base station identification information for identifying the eNB 25, the application identification information, the application user identification information, and the ProSe code may be transmitted in the state of being included in the message. The ProSe capability information may be the capability information indicating that the direct communication path to the neighboring UE can be established and may be the capability information indicating that the ProSe service can be enjoyed. Furthermore, the ProSe capability information may be the information indicating that the ProSe service is enjoyed and may be the information indicating that the direct communication path to the neighboring terminal is established, and these pieces of information may be included, as the different pieces of identification information, in the message.

Furthermore, the information for identifying the position management device may include the information for identifying the MME 30 that has so far performed the position management of the UE-R 15. Additionally, information for identifying the MME-A 35 may be included. Without being limited to these, the information that is included in the context request message in the related art may be together included in the message.

The application identification information is the identification information for identifying the application that is used in the ProSe service in which the UE-R establishes the direct communication path between the UE-R itself and the different UE.

The application user identification information may be the identification information for identifying the user or the UE-R 15 in the application that is identified with the application identification information.

The ProSe code may be the information that is transmitted when the UE announces to the different UE that is located nearby that the UE itself is located near the different UE. Additionally, the ProSe code may be the information that is received when the different UE that is located nearby performs the monitoring to know if the different UE itself is located near the UE. The ProSe code may be constituted by combining the application identification information, the information for identifying the UE, and the identification information for identifying the operator network such as the PLMN. Additionally, the information for identifying the UE may be the subscriber identification information, such as the IMSI, may be the identification information, such as the TEID, that is temporarily allocated, and may be the application user identification information or the like.

Additionally, a flag for requesting the information for identifying the ProSe Server 90 which provides a direct communication service between neighboring terminals to the UE-R 15 may be included in the message.

Based on the reception of the context request message, the MME 30 may transmit a context response message to the MME-A 35 (S1308).

The MME 30 may transmit the MME communication path context 442 that is managed in a state of being associated with the UE-R 15, and may transmit information that is managed in the MME communication path context 442, in the state of being included in the message.

Here, the MME 30 may select the MME communication path context 442 that is managed in a state of being associated with the UE-R 15, based on the information for identifying the UE-R 15 that is included in the context request message, and may cause the selected MME communication path context 442 to be included.

Furthermore, the MME 30 may cause the information for identifying the ProSe Server 90 which provides the direct communication service between the neighboring terminals to the UE-R 15, to be included in a context response, and may transmit the context response including the information for identifying the ProSe Server 90.

Additionally, whether or not to include the information for identifying the ProSe Server 90 may be determined depending on the presence or absence of the flag for requesting the information for identifying the ProSe Server 90, which is included in the context request message.

For example, in a case where the context request message in which the flag for requesting the information for identifying the ProSe Server 90 is included is received, the message is transmitted in a state where the information for identifying the ProSe Server 90, which is retained by the MME-A 35 and which is managed in the state of being associated with the UE-R 15, is included in the message itself.

Furthermore, in a case where the flag for requesting the information for identifying the ProSe Server 90 is not included in the context request message, the message is transmitted in a state where the information for identifying the ProSe Server 90 is not included in the message itself.

Furthermore, in a case where the information for identifying the ProSe Server 90 is not managed for the UE-R 15, the context response may be transmitted in a state where the information for identifying the ProSe Server 90 is not included in the context response itself.

Additionally, the MME 30 may determine whether or not to include the information for identifying the ProSe Server 90, depending on the presence or absence of ProSe capability information on the UE-R 15, which is included in the context request message.

For example, in a case where the context request message in which the ProSe capability information on the UE-R 15 is included is received, the message is transmitted in the state where the information for identifying the ProSe Server 90, which is retained by the MME-A 35 and which is managed in the state of being associated with the UE-R 15, is included in the message itself.

Furthermore, in a case where the ProSe capability information on the UE-R 15 is not included in the context request message, the message is transmitted in the state where the information for identifying the ProSe Server 90 is not included in the message itself.

Furthermore, in the case where the information for identifying the ProSe Server 90 is not managed for the UE-R 15, the context response may be transmitted in a state where the information for identifying the ProSe Server 90 is not included in the context response itself.

The ProSe capability information may be the capability information indicating that the direct communication path to the neighboring UE can be established and may be the capability information indicating that the ProSe service can be enjoyed. Furthermore, the ProSe capability information may be the information indicating that the ProSe service is enjoyed and may be the information indicating that the direct communication path to the neighboring terminal is established.

Additionally, whether or not to include the information for identifying the ProSe Server 90 may be determined depending on the presence or absence of the application identification, the application user identification information, the ProSe code, or the like, which is included in the context request message.

For example, in a case where the context request message in which the application identification information, the application user identification, or the ProSe code is included is received, the message is transmitted in the state where the information for identifying the ProSe Server 90, which is retained by the MME-A 35 and which is managed in the state of being associated with the UE-R 15, is included in the message itself.

Furthermore, in a case where the application identification information, the application user identification information, or the ProSe code is not included in the context request message, the message is transmitted in the state where the information for identifying the ProSe Server 90 is not included in the message itself.

Furthermore, in the case where the information for identifying the ProSe Server 90 is not managed for the UE-R 15, the context response may be transmitted in the state where the information for identifying the ProSe Server 90 is not included in the context response itself.

In this manner, whether or not the UE-R 15 receives the ProSe service may be determined depending on the presence or absence of the application identification information, the application user identification information, or the ProSe code.

The MME 30 may perform the transmission in a state where the information for identifying the ProSe Server 90 is included, based on either of the flag for requesting the information for identifying the ProSe Server 90, the capability information indicating that the ProSe Server can be enjoyed, and the information indicating that the direct communication path is established between the neighboring terminals. The MME 30 may determine that the pieces of information described above are included in combination, such as when it is determined that the multiple pieces of information described above are included, and may perform the transmission in a state where the information for identifying the ProSe Server 90 is included.

The MME-A 35 receives the context response from the MME 30. In a case where the information for identifying the ProSe Server 90 is included in the context response, the MME-A 35 stores the name of the ProSe Server 90 in the MME communication path context 442. Furthermore, a database for storage is not limited to the MME communication path context 442, and may be a database, such as an MM context. Furthermore, the information for identifying the ProSe Server 90 may be stored in a state of being associated with the information for identifying the UE-R 15.

The MME-A 35 transmits a context ACK to the MME 30 based on reception of the context response, and completes the relocation (MME-Allocation) of the position management device (S1310).

Additionally, the MME-A 35 may transmit a bearer update request message to the SGW 40 (S1312). Accordingly, the MME-A 35 may request that QoS information on the PDN connection which is established by the UE-R between the UE-R itself and the PGW 50 should be updated. Furthermore, a request may be made for an update of the QoS information on the bearer that is associated with the PDN connection. Furthermore, a request may be made for the update of the QoS information on the direct communication path that is established by the UE-R between the UE-R itself and the UE 10.

Information for identifying the PDN connection, or information for identifying the communication path, such as information for identifying the direct communication path between the UE-R itself and the UE 10 may be transmitted in the state of being included in the message. Additionally, the QoS information that corresponds to the communication path may be transmitted in the state of being included in the message.

The SGW 40 receives a bearer request message, and based on the reception of the bearer request message, the SGW 40 and the PGW 50 execute a bearer update procedure (S1314). In the bearer update procedure, the QoS information on the PDN connection that is established by the UE-R between the UE-R itself and the PGW 50 may be updated. Furthermore, a request may be made for the update of the QoS information on the bearer that is associated with the PDN connection. Furthermore, the QoS information in the direct communication path that is established by the UE-R between the UE-R itself and the UE 10 may be updated.

After the bearer update procedure that is executed by the SGW 40 and the PGW 50 is completed, the SGW 40 transmits a bearer update response message to the MME-A 35 (S1316).

Based on the reception of the bearer update response message, the MME-A 35 transmits a tracking area update acceptance message to the UE-R 15 (S1318). By transmitting the tracking area update acceptance message, the MME-A 35 may notify that the tracking area is updated, in response to the request for an update of the tracking area that is made by the UE-R 15.

The updated QoS information on the PDN connection that is established between the UE-R 15 and the PGW 50 may be transmitted in the state of being included in the message.

The updated QoS information on the PDN connection that is established between the UE-R 15 and the UE 10 may be transmitted in the state of being included in the message.

Additionally, pieces of information relating to the radio bearers that are these communication paths may be included. For example, pieces of information relating to the radio resource for the communication path, such as a frequency and time information such as a transmission timing may be transmitted in the state of being included in the message. The MME-A 35 may newly perform allocation of the radio resource, and information relating to the newly-allocated radio resource may be notified in the state of being included in the message. The information relating to the radio resource may be acquired from the information that is included in the bearer update response message from the SGW 40, and the acquired information relating to the radio resource may be notified to the UE-R 15.

Additionally, the information for identifying the MME-A 35 may be transmitted in a state of being included in the tracking area update acceptance message. In this manner, by transmitting the message to the UE-R 15, in the state where the MME-A 35 is included in the message itself, the MIME-A 35 may notify that the position management device is relocated (MME-Allocation).

The UE-R 15 may receive a tracking area update acceptance from the MME-A 35 and, based on the reception thereof, may transmit a tracking area update completion message to the MME-A 35 (S1320). Subsequent to this, the UE-R 15 completes the tracking area update procedure that is accompanied by the relocation (MME-Allocation) of the position management device.

Additionally, based on the information that is included in the tracking area update acceptance, the UE-R 15 may update the information relating to the radio bearer. For example, the pieces of information relating to the radio resource for the communication path, such as the frequency and the time information such as the transmission timing may be updated. When it comes to the pieces of information relating to the radio resource, the information relating to the direct communication path between the UE-R 15 and the UE 10 may be updated, and the information relating to the PDN connection between the UE-R 15 itself and the PGW 50.

Additionally, the UE-R 15 may notify the UE 10 that the radio resource relating to the direct communication path is updated and may make a request for an update of the information relating to the radio resource that is retained by the UE 10. The information relating to the radio resource that is included in the tracking request acceptance may be notified in a state of being included in such a request.

With the above-described procedure, in the state of the idle mode, the UE-R 15 can perform the update of the tracking area that is accompanied by the relocation (MME-Allocation) of the position management device.

Additionally, in the above-described procedure, the update of the tracking area, as well as the relocation (MME-Allocation) of the position management device, can be performed without changing the ProSe Server that manages the direct communication service between the neighboring terminals using the direct communication path between the UE-R 15 and the UE 10. To realize this, when the UE-R 15 moves in the state of the idle mode, the MME-A 35, which is the position management device which manages the base station that is a destination, acquires the ProSe Server that is retained by the MME 30 before the UE-R 15 moves.

Furthermore, the UE-R 15, although in the idle mode in which the radio resource between the UE-R 15 itself and the base station, can maintain the communication that uses the direct communication path between the UE-R 15 itself and the UE 10, and performs the transmission and reception of data that use the direct communication path. When the UE-R 15 can transition to the idle mode, radio resources of the entire communication system can be effectively used by releasing the radio resource between the UE-R 15 itself and the base station.

Furthermore, in the above-described procedure, following such a movement of the UE-R 15 in the idle mode, although the position management device is relocated, the MME-A 35 that is the position management device which manages the base station that is the destination can acquire the ProSe Server that is retained by the MME 30 before the UE-R 15 moves. Because of this, the ProSe Server 90 is not changed, and the UE-R 15 can maintain the establishment of the direct communication path for the neighboring terminal such as the UE 10, and the transmission and reception of data that use the direct communication path.

Furthermore, the UE-R 15 may transmit request information for requesting the MME-A 35 to acquire the information for identifying the ProSe Server 90, in a state of being included in a tracking area update request.

Any request information with which the need for the MME-A 35 to acquire the information for identifying the ProSe Server 90 can be detected may be used and the request information may be the ProSe capability information on the UE-R 15. The ProSe capability information may be the capability information indicating that the direct communication path to the neighboring UE can be established and may be the capability information indicating that the ProSe service can be enjoyed. Furthermore, the ProSe capability information may be the information indicating that the ProSe service is enjoyed and may be the information indicating that the direct communication path to the neighboring terminal is established.

Alternatively, the ProSe capability information may be a flag for requesting the ProSe Server 90 is acquired, or the like.

Additionally, the eNB 25 may receive the tracking area update request message in which request information for requesting that the MME-A 35 should acquire the information for identifying the ProSe Server 90 is included, and may transmit the received tracking area update request message to the MME-A 35.

Based on whether or not the request information for requesting that the MME-A 35 should acquire the information for identifying the ProSe Server 90 is included in the tracking area update request message that is received from the UE-R 15, the received request information may be transmitted in a state of being included in the tracking area update message that is transmitted to the MME-A 35.

Furthermore, based on the whether or not the request formation for requesting that the MME-A 35 should acquire the information for identifying the ProSe Server 90 is included in the received tracking area update request message, the MME-A 35 may include the flag for requesting the information for identifying the ProSe Server 90 that provides the direct communication service between the neighboring terminals to the UE-R 15, in the context request message that is transmitted to the MME 30.

For example, in a case where the request formation for requesting that the MME-A 35 should acquire the information for identifying the ProSe Server 90 is included in the received tracking area update request message, the MME-A 35 transmits the context request message to the MME 30, in a state where the flag for requesting the information for identifying the ProSe Server 90 that provides the direct communication service between the neighboring terminals to the UE-R 15 is included in the context request message itself.

Furthermore, in a case where the request formation for requesting that the MME-A 35 should acquire the information for identifying the ProSe Server 90 is not included in the received tracking area update request message, the MME-A 35 transmits the context request message to the MME 30, in a state where the flag for requesting the information for identifying the ProSe Server 90 that provides the direct communication service between the neighboring terminals to the UE-R 15 is not included in the context request message itself.

Accordingly, only when the communication terminal that can establish the direct communication path makes a request to the MME-A 35 for the update of the tracking area, the MME-A 35 can acquire the information for identifying the ProSe Server 90. In other words, in a case where a communication terminal in the related art that has the difficulty in performing the establishment of the direct communication path, or the communication terminal in which a function of performing the establishment of the direct communication path or the like is disabled makes the tracking area update request, the MME-A 35 ends up without acquiring the information for identifying the ProSe Server 90. Furthermore, the MME-A 35 may receive the information for identifying the ProSe Server 90 from the MME 30, and may notify the ProSe Server 90 that the position management device which performs the position management of the UE-R 15 is updated.

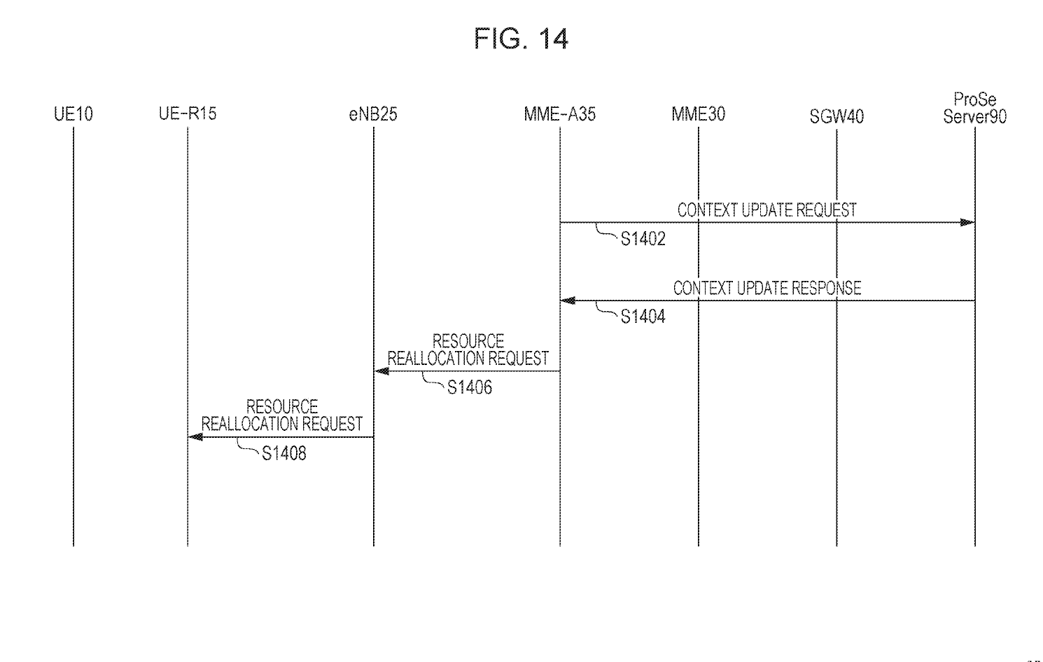

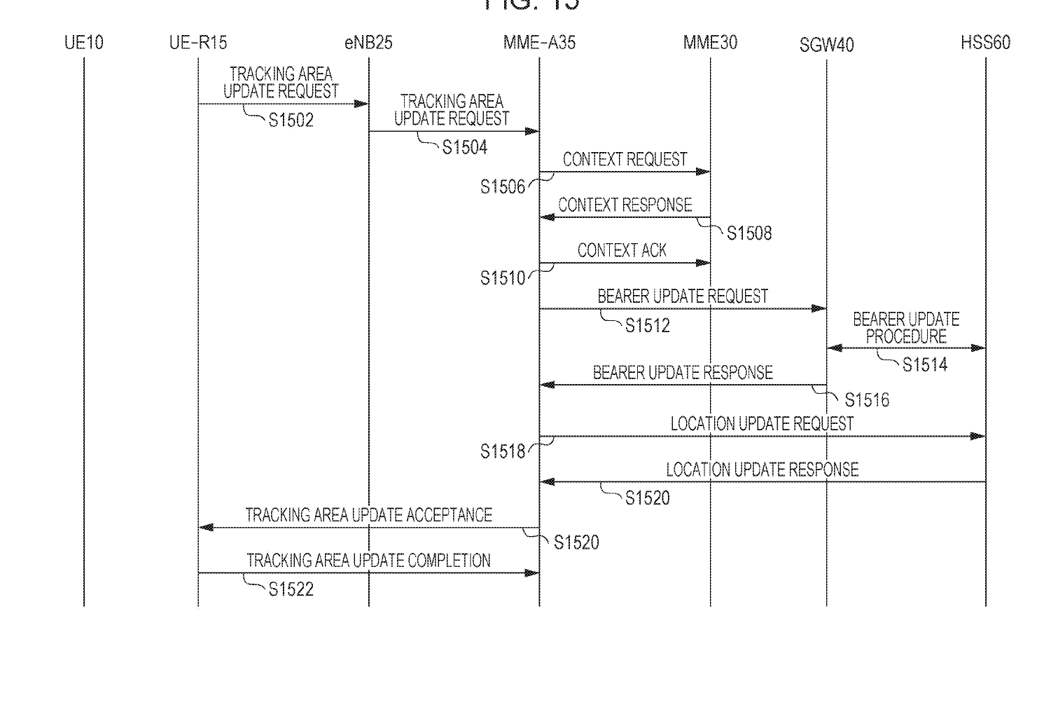

An update procedure that is executed by the position management device is described referring to FIG. 14. The MME-A 35 transmits a context update request message to the ProSe Server 90 (S1402). The information for identifying the MME-A, the information for identifying the UE-R 15, the application identification information, the application user identification information the ProSe code may be transmitted in the state of being included in the message, and the update by the position management device may be requested.

Pieces of information that are included in the tracking area update request message that is transmitted by the UE-R 15 may be stored in the information for identifying the UE-R 15, the application identification information, the application user identification information, and the Prose code may be read for transmission.

The transmission of the context request message by the MME-A 35 may be performed based on the reception of the context response from the MME 30 (S1308), which is described above referring to FIG. 13. Furthermore, the transmission of the context request message by the MME-A 35 may be performed based on the transmission of the context ACK to the MME 30 (S1310). Alternatively, the transmission of the context request message by the MME-A 35 may be performed based on the reception of the bearer update response (S1316) from the SGW 40.

The ProSe Server 90 may receive the context update request message and may update and retain the information for identifying the position management device, which is included in the message. For example, the ProSe Server 90 may retain the information for identifying the MME 30 as the position management device, in a state of being associated with the UE-R 15, and, based on the reception of the context request message, may update information on the position management of the UE-R 15 from the MME 30 to the MME-A 35 for management.

Based on the reception of the context update request message, the ProSe Server 90 may transmit a context update response message to the MME-A 35 (S1404). Alternatively, based on an update of information that corresponds to the position management device for the UE-R 15, the context update response message may be transmitted to the MME-A 35.

In this manner, by transmitting the context update response message, the ProSe Server 90 may update the information that corresponds to the position management device for the UE-R 15 and may notify that the update is completed.

Furthermore, the ProSe Server 90 may include the information relating to the radio bearer that is the direct communication path, which is established by the UE-R 15 between the UE-R 15 itself and the UE 10. For example, the pieces of information relating to the radio resource for the communication path, such as the frequency and the time information such as the transmission timing may be transmitted in the state of being included in the message. The ProSe Server 90 may newly perform the allocation of the radio resource, and the information to the newly-allocated radio source may be notified in the state of being included in the message. The information relating to the radio resource that is already allocated to the direct communication path between the UE-R 15 and the UE 10 may be retained and the retained information may be read.

The MME-A 35 may receive a context update response, and based on the reception thereof, may transmit a resource reallocation request message to the eNB 25. The information relating to the radio bearer that is the communication path may be included in the message. For example, the pieces of information relating to the radio resource for the communication path, such as the frequency and the time information such as the transmission timing may be transmitted in the state of being included in the message.

The information relating to the radio resource may be transmitted in a state of including the information that is notified by the ProSe Server 90. Alternatively, the MIME-A 35 may newly perform the allocation of the radio resource, and the information relating to the radio resource may be notified in the state of being included in the message.

The eNB 25 may receive the resource reallocation request message and based on the reception thereof, may transmit the resource reallocation request message to the UE-R 15. The information relating to the radio bearer that is the communication path may be included in the message. For example, the pieces of information relating to the radio resource for the communication path, such as the frequency and the time information such as the transmission timing may be transmitted in the state of being included in the message.

The information relating to the radio resource may be transmitted in the state of including the information that is notified by the MME-A 35. Alternatively, the eNB 25 may newly perform the allocation of the radio resource, and the information relating to the radio resource may be notified in the state of being included in the message.

The UE-R 15 may receive the resource reallocation request message and based on the reception thereof, may transmit the resource reallocation request message to the UE 10. The information relating to the radio bearer that is the communication path may be included in the message. For example, the pieces of information relating to the radio resource for the communication path, such as the frequency and the time information such as the transmission timing may be transmitted in the state of being included in the message.

The information relating to the radio resource may be transmitted in the state of including the information that is notified by the eNB 25. Alternatively, the UE-R 15 may newly perform the allocation of the radio resource, and the information relating to the radio resource may be notified in the state of being included in the message.

As described above, in the ProSe Server 90, an update of the information for identifying the position management device, which is associated with the UE-R 15 may be performed. Additionally, the reallocation of the radio resource for the direct communication path between the UE-R 15 and the UE 10 may be performed.

[1.3.6 Modification Example of the Tracking Area Update Procedure]

The tracking area update procedure that is executed when the UE-R 15 is in the state of the idle mode is not limited to the method that is described Chapter 1.3.5, and may be a procedure that is based on a modification example that will be described below.

In the method that is described in Chapter 1.3.5, the MME-A 35 acquires the information for identifying the ProSe Server 90 from the MME 30. More specifically, the MME-A 35 transmits a context request, receives the context response that is transmitted from the MME 30 to the MME-A 35, and acquires the information for identifying the ProSe Server 90 that is included in the context response.

In contrast, the main difference from the method that is described in Chapter 1.3.5 is that according to the present embodiment, the MME-A 35 acquires the information for identifying the ProSe Server 90 from the HSS 60.

The modification example of the tracking area update procedure that is executed when the UE-R 15 is in the state of the idle mode is described referring to FIG. 15.

The state of the idle mode is the state in where, in the case were the UE-R 15 does not perform the transmission and reception of data for a fixed time or more while using the communication path that the UE-R 15 establishes by making a connection to the PDN 80 through the eNB 20 and the core network 7, the wireless connection between the access network such as the LTE AN 15 and the UE-R 15 is released.

More specifically, in the case where the transmission and reception of data that use the PDN network which is established between the UE-R 15 and the PGW 50 is not performed for a fixed time or more, the UE-R 15, the eNB 20, or the apparatus that is constituted to be in the core network 7 initiatively releases the radio bearer between the UE-R 15 and the eNB 20 is released. In the release of the radio bearer, the information that is associated with the radio bearer, such as the radio bearer ID, and that is retained by each of the UE-R 15 and the eNB 20 is deleted, or the radio resource, such as the frequency is released.

In this manner, the UE-R15 transitions to the state of the idle mode, and this releases the radio resource that is not used throughout the communication system as a whole. Thus, the limited radio resource can be used efficiently in such a manner that the different UE and the like can use the released radio source.

The tracking area update procedure is executed to know the location of the UE-R 15 in such an idle mode. Because the UE-R 15 releases the radio bearer between the UE-R 15 itself and the eNB 20 and the connectivity at the radio level is not present, following the movement of the UE-R 15, the apparatus that is constituted to be in the core network 7 such as the MME 30 has the difficulty in knowing which the eNB 20 the UE-R 15 is located near.

Accordingly, in the state of the idle mode, by using the timer that is configured in advance, and so forth, the UE-R 15 periodically executes the tracking area update procedure and notifies which base station device the UE-R 15 can make a connection to. Furthermore, as far as the MME 30, the SGW 40, or the apparatus that is constituted to be in the core network 7 such as the PGW 50, is concerned, which base station device the UE-R 15 in the idle mode is located near or which base station device the UE-R 15 makes a connection to can be detected.

Here, in the MME 30, the connectivity to the multiple base station device groups that includes the eNB 20 is established, and the area called the tracking area is constituted. For example, the MME 30 can manage the base station group that is constituted to be within the area near which the physical location is, and can constitute such an area, as the tracking area. Furthermore, regardless of whether or not the physical location is nearby, the base station group that is associated with the tracking area can be constituted, for example, by selecting and constituting the base station that the communications carrier wants to manage in a distinguished manner in terms of operation. More precisely, with the MME 30 being associated with the MME 30, the multiple base stations can be managed and the tracking area can be constituted.

In this manner, the terminal device in the idle state makes a request to the base station that constitutes the cell, for the registration with the tracking area, and in the position management device, the terminal device is registered with the tracking area and which tracking area the terminal device is located at is managed. Additionally, the tracking area is managed with the tracking list, and the base station or the terminal device may be managed in the state of being associated with the tracking area. Moreover, the position management device can manage the multiple tracking areas, and can retain the multiple tracking area lists. Additionally, the terminal device may be managed in the state of being associated with each of the multiple tracking area that are managed by the same position management device.

The multiple position management devices may be constituted in the core network 7, separately from the MME 30. For example, the MME 30 and an MME-A 35 may be constituted in the core network 7. The MME-A 35 is different from the MME 30 in terms of the tracking area that is managed in the MME 30, and, except for this difference, has the same constitution as the MME 30. Accordingly, a repetitive description of the constitution of the MME-A 35 is omitted.

In the case where the UE-R 15 in the state of the idle mode executes the tracking area update procedure, in some cases, the UE-R 15 makes connections to the different base stations before and after the transfer update procedure is executed due to the movement of the UE-R15. Additionally, in some cases, the position management devices that manage the base stations, respectively, are the different position management devices. For example, the UE-R 15 moves from the base station device that is managed by the MME 30 to near the base station device that is managed by the MME-A 35, and executes the tracking area update procedure.

The tracking area update procedure in which the movement to the tracking area that is managed by the different position management devices takes place as described above will be described below. The tracking area update procedure is the procedure in which the MME-A 35 detects that the UE-R 15 moves from the base station that is managed by the MME 30 to the base station that is managed by the MME-A 35. Furthermore, as far as the UE-R15 is concerned, this is the procedure for the movement from the tracking area that is managed by the MME 30 to the tracking area that is managed by the MME-A 35, and in the tracking area update procedure, the reallocation (MME-Allocation) of the position management device is performed.

The tracking area update procedure that includes the reallocation of the position management device is described referring to FIG. 15.

First, the initial state of the tracking area update procedure that is initiatively executed by the UE-R 15 is described.

With the above-described procedure, the UE-R 15 makes a connection to the core network 7 through the eNB 20, and establishes the PDN connection between the UE-R 15 itself and the PGW 50. Additionally, the direct communication path between the UE-R 15 itself and the neighboring UE 10 is established. The UE-R 15 performs the transmission and reception of data using such a communication path.

Additionally, if the transmission and reception of data that use the PDN connection between the UE-R 15 itself and the PGW 50 is not performed for a fixed time or more, the radio bearer between the UE-R 15 and the eNB 20 is released and the transitioning to the idle mode takes place.

Here, the initial states in the procedure that is described according to the present embodiment are not limited to this, and may be arbitrary states that include the state in the related art, in which the UE-R 15 updates the tracking area. Additionally, the method in which the UE-R 15 establishes the PDN connection between the UR-R 15 and the PGW 50 or the method of establishing the direct communication path between the UE-R 15 itself and the UE 10 is not limited to the above-described method, and may be established with other methods. Furthermore, regardless of whether or not the state of the idle mode is present, the UE-R 15 may execute the tracking update procedure in the active mode.

In such an initial state, the UE-R 15 transmits the tracking area update request message to the eNB25 (S1502). The information for identifying the UE-R 15, the information for identifying the tracking area, the information for identifying the position management device, the ProSe capability information, the application identification information, the application user identification information, and the ProSe code may be transmitted in the state of being included in the message. The ProSe capability information may be the capability information indicating that the direct communication path to the neighboring UE can be established and may be the capability information indicating that the ProSe service can be enjoyed. Furthermore, the ProSe capability information may be the information indicating that the ProSe service is enjoyed and may be the information indicating that the direct communication path to the neighboring terminal is established, and these pieces of information may be included, as the different pieces of identification information, in the message.

Furthermore, the information for identifying the position management device may include the information for identifying the MIME 30 that has so far performed the position management of the UE-R 15. Without being limited to these, the information that is included in the tracking area update request message in the related art may be together included in the message.

The application identification information is the identification information for identifying the application that is used in the ProSe service in which the UE-R establishes the direct communication path between the UE-R itself and the different UE.

The application user identification information may be the identification information for identifying the user or the UE-R 15 in the application that is identified with the application identification information.

The ProSe code may be the information that is transmitted when the UE announces to the different UE that is located nearby that the UE itself is located near the different UE. Additionally, the ProSe code may be the information that is received when the different UE that is located nearby performs the monitoring to know if the different UE is located near the UE. The ProSe code may be constituted by combining the application identification information, the information for identifying the UE, and the identification information for identifying the operator network such as the PLMN. Additionally, the information for identifying the UE may be the subscriber identification information, such as the IMSI, may be the identification information, such as the TEID, that is temporarily allocated, and may be the application user identification information or the like.

For the triggering of the transmission of the tracking area update request message by the UE-R 15, the transmission timing may be determined based on the timer that starts from the timing at which the UE-R 15 in the state of the idle mode transitions to the active mode. Furthermore, the UE-R 15 may in advance retain the timer that determines the interval at which the tracking area update request message is transmitted may be determined, and may determine the value of the timer.

The eNB 25 receives the tracking area update request message. The eNB 25 may be the base station device that has the connectivity to the MME-A 35, and may be the base station device that belongs to the tracking area that is managed by the MME-A 35. In other words, the eNB 25 is the base station device that is managed by the MME-A 35, and is the base station device that belongs to the tracking area that is constituted by the MME-A 35. Here, the eNB 25 may be the base station device that is different from the eNB 20 that is constituted to be in the LTE AN 9. Furthermore, the tracking area to which the eNB 25 belongs and the tracking area to which the eNB 20 belongs may be the different tracking areas. Additionally, each of the tracking areas may be the tracking area that is managed by the MME 30. The tracking areas may be managed by the different position management devices, such as when the tracking area to which the eNB 25 belong is managed by the MME-A 35, and when the tracking areas to which the eNB 20 belongs is managed by the MME 30. Furthermore, because the constitution of the eNB 25 may be the same as the constitution of the eNB 20 that is already described, a detailed description thereof is omitted.

Here, the UE-R 15 periodically executes the tracking area update procedure. When it comes to the tracking update procedure that is previously executed, the UE-R 15 may transmit the tracking area update request message to the eNB 20 and may execute the track area update procedure.

The eNB 20 may be the base station device that has the connectivity to the MME 30, and may be the base station device that belongs to the tracking area that is managed by the MME 30. In other words, the eNB 20 is the base station device that is managed by the MME 30, and is the base station device that belongs to the tracking area that is constituted by the MME 30.

More precisely, with the present tracking area update, the UE-R15 transmits the tracking area update request message to the base station device that is different from the base station which transmits the tracking area update request message earlier. Additionally, the base station that receives the tracking area update request message is the base station that is different from the preceding base station, and that is managed by the position management device.

Based on the reception of the tracking area update request from the UE-R 15, the eNB 25 may transmit the tracking area update request to the MME-A 35 (S1504). The information for identifying the UE-R 15, the information for identifying the tracking area, the information for identifying the position management device, the ProSe capability information, the base station identification information for identifying the eNB 25, the application identification information, the application user identification information, and the ProSe code may be transmitted in the state of being included in the message. The ProSe capability information may be the capability information indicating that the direct communication path to the neighboring UE can be established and may be the capability information indicating that the ProSe service can be enjoyed. Furthermore, the ProSe capability information may be the information indicating that the ProSe service is enjoyed and may be the information indicating that the direct communication path to the neighboring terminal is established, and these pieces of information may be included, as the different pieces of identification information, in the message.

Furthermore, the information for identifying the position management device may include the information for identifying the MME 30 that has so far performed the position management of the UE-R 15. Without being limited to these, the information that is included in the tracking area update request message in the related art may be together included in the message.

The application identification information is the identification information for identifying the application that is used in the ProSe service in which the UE-R establishes the direct communication path between the UE-R itself and the different UE.

The application user identification information may be the identification information for identifying the user or the UE-R 15 in the application that is identified with the application identification information.

The ProSe code may be the information that is transmitted when the UE announces to the different UE that is located nearby that the UE itself is located near the different UE. Additionally, the ProSe code may be the information that is received when the different UE that is located nearby performs the monitoring to know if the different UE is located near the UE. The ProSe code may be constituted by combining the application identification information, the information for identifying the UE, and the identification information for identifying the operator network such as the PLMN. Additionally, the information for identifying the UE may be the subscriber identification information, such as the IMSI, may be the identification information, such as the TEID, that is temporarily allocated, and may be the application user identification information or the like.

Based on the reception of the tracking area update message that is transmitted from the eNB 25, the MME-A 35 may transmit a context request message to the MME 30 (S1506). With the transmission of such a context supply message, the MME-A 35 may initiatively perform the reallocation (MME-Allocation) of the position management device.

Based on the information that is included in the received tracking area update message, the MME-A 35 may select the position management device that transmits the context request message. For example, the tracking area information and the position management device may be managed in advance in the state of being associated with each other, the position management device that is associated with the received tracking area information may be selected, and it may be determined that the message is transmitted to the MME 30. Furthermore, the position management device may be selected with the information for identifying the position management device, which is included in the tracking area request message, and the message may be transmitted to the MME 30.

The information for identifying the UE-R 15, the information for identifying the tracking area, the information for identifying the position management device, the ProSe capability information, the base station identification information for identifying the eNB 25, the application identification information, the application user identification information, and the ProSe code may be transmitted in the state of being included in the message. The ProSe capability information may be the capability information indicating that the direct communication path to the neighboring UE can be established and may be the capability information indicating that the ProSe service can be enjoyed. Furthermore, the ProSe capability information may be the information indicating that the ProSe service is enjoyed and may be the information indicating that the direct communication path to the neighboring terminal is established, and these pieces of information may be included, as the different pieces of identification information, in the message.

Furthermore, the information for identifying the position management device may include the information for identifying the MME 30 that has so far performed the position management of the UE-R 15. Additionally, the information for identifying the MME-A 35 may be included. Without being limited to these, the information that is included in the context request message in the related art may be together included in the message.

The application identification information is the identification information for identifying the application that is used in the ProSe service in which the UE-R establishes the direct communication path between the UE-R itself and the different UE.

The application user identification information may be the identification information for identifying the user or the UE-R 15 in the application that is identified with the application identification information.

The ProSe code may be the information that is transmitted when the UE announces to the different UE that is located nearby that the UE itself is located near the different UE. Additionally, the ProSe code may be the information that is received when the different UE that is located nearby performs the monitoring to know if the different UE is located near the UE. The ProSe code may be constituted by combining the application identification information, the information for identifying the UE, and the identification information for identifying the operator network such as the PLMN. Additionally, the information for identifying the UE may be the subscriber identification information, such as the IMSI, may be the identification information, such as the TEID, that is temporarily allocated, and may be the application user identification information or the like.

Based on the reception of the context request message, the MME 30 may transmit the context response message to the MME-A 35 (S1508).

The MME 30 may transmit the MME communication path context 442 that is managed in the state of being associated with the UE-R 15, and may transmit the information that is managed in the MME communication path context 442, in the state of being included in the message.

Here, the MME 30 may select the MME communication path context 442 that is managed in the state of being associated with the UE-R 15, based on the information for identifying the UE-R 15 that is included in the context request message, and may cause the selected MME communication path context 442 to be included.

The MME-A 35 receives the context response from the MME 30. The MME-A 35 transmits the context ACK to the MME 30 based on the reception of the context response, and completes the relocation (MME-Allocation) of the position management device (S1510).

Additionally, the MME-A 35 may transmit the bearer update request message to the SGW 40 (S1512). Accordingly, the MME-A 35 may request that the QoS information on the PDN connection which is established by the UE-R between the UE-R itself and the PGW 50 should be updated. Furthermore, a request may be made for the update of the QoS information on the bearer that is associated with the PDN connection. Furthermore, a request may be made for the update of the QoS information on the direct communication path that is established by the UE-R between the UE-R itself and the UE 10.

The information for identifying the PDN connection, or the information for identifying the communication path, such as the information for identifying the direct communication path between the UE-R itself and the UE 10 may be transmitted in the state of being included in the message. Additionally, the QoS information that corresponds to the communication path may be transmitted in the state of being included in the message.

The SGW 40 receives the bearer request message, and based on the reception of the bearer request message, the SGW 40 and the PGW 50 execute the bearer update procedure (S1314). In the bearer update procedure, the QoS information on the PDN connection that is established by the UE-R between the UE-R itself and the PGW 50 may be updated. Furthermore, a request may be made for the update of the QoS information on the bearer that is associated with the PDN connection. Furthermore, the QoS information in the direct communication path that is established by the UE-R between the UE-R itself and the UE 10 may be updated.

After the bearer update procedure that is executed by the SGW 40 and the PGW 50 is completed, the SGW 40 transmits the bearer update response message to the MME-A 35 (S1516).

The MME-A 35 may transmit a location registration request message to the HSS 60 (S1518). The MME-A 35 may in advance retain information for identifying the HSS 60 and may select the information for identifying the HSS 60 as a destination of a location registration request message. Transmission of a location update request transmission may be transmitted based on the reception of the bearer update response, and may be performed based on the transmission of the context ACK.

Additionally, the information for identifying the UE-R 15, the information for identifying the MME-A 35, the flag for requesting the information for identifying the ProSe Server 90 which provides the direct communication service between the neighboring terminals to the UE-R 15 may be included in the message, and the like may be included in the location update request. Additionally, information, such as the application identification information, the application user identification information, or the ProSe code may be included.

The flag for requesting the information for identifying the ProSe Server 90 may be a flag for simply requesting the information for identifying the ProSe Server 90, and may be the Prose capability information.

The prose capability information may be the capability information indicating that the direct communication path to the neighboring UE can be established and may be the capability information indicating that the ProSe service can be enjoyed. Furthermore, the prose capability information may be the information indicating that the ProSe service is enjoyed and may be the information indicating that the direct communication path to the neighboring terminal is established, and these pieces of information may be included, as the different pieces of identification information, in the message.

The HSS 60 manages subscriber information on the UE-R 15, receives the location update request, and updates the information for identifying the position management device that manages the UE-R 15, from the MME 30 to the MME-A 35.

The application identification information is the identification information for identifying the application that is used in the ProSe service in which the UE-R establishes the direct communication path between the UE-R itself and the different UE.

The application user identification information may be the identification information for identifying the user or the UE-R 15 in the application that is identified with the application identification information.

The ProSe code may be the information that is transmitted when the UE announces to the different UE that is located nearby that the UE itself is located near the different UE. Additionally, the ProSe code may be the information that is received when the different UE that is located nearby performs the monitoring to know if the different UE is located near the UE. The prose code may be constituted by combining the application identification information, the information for identifying the UE, and the identification information for identifying the operator network such as the PLMN. Additionally, the information for identifying the UE may be the subscriber identification information, such as the IMSI, may be the identification information, such as the TEID, that is temporarily allocated, and may be the application user identification information or the like.

The HSS 60 may transmit a location update response message to the MME-A 35. The transmission of the message may be performed based on the location update request. Furthermore, the transmission of the message may be performed based on an update of the subscriber information and of the information for identifying the position management device.

Additionally, the HSS 60 may transmit the information for identifying the ProSe Server 90, in a state of being included in the location update response message. The HSS 60 may retain the information for identifying the ProSe Server 90 in a state of being associated with the subscriber information, may read the retained information for identifying the ProSe Server 90, and may transmit the read information for identifying the ProSe Server 90 in the state of being included in the location update response message.

Based on the reception of the location update request, the HSS 60 may transmit the information for identifying the ProSe Server 90 in the state of being included in the location update response message.

Furthermore, whether or not to include the information for identifying the ProSe Server 90 may be determined depending on the presence or absence of the flag for requesting the information for identifying the ProSe Server 90, which is included in a location update request message.

For example, in the case where the context request message in which the flag for requesting the information for identifying the ProSe Server 90 is included is received, the message is transmitted in a state where the information for identifying the ProSe Server 90, which is retained by the HSS 60 and which is managed in the state of being associated with the UE-R 15, is included in the message itself.

Furthermore, in the case where the flag for requesting the information for identifying the Prose Server 90 is not included in the context request message, the message is transmitted in the state where the information for identifying the Prose Server 90 is not included in the message itself.

Furthermore, in the case where the information for identifying the ProSe Server 90 is not managed for the UE-R 15, the context response may be transmitted in the state where the information for identifying the ProSe Server 90 is not included in the context response itself.

Additionally, the HSS 60 may determine whether or not to include the information for identifying the ProSe Server 90, depending on the presence or absence of the Prose capability information on the UE-R 15, which is included in the context request message.

For example, in a case where the location update request message in which the ProSe capability information on the UE-R 15 is included is received, the message is transmitted in a state where the information for identifying the ProSe Server 90, which is retained by the HSS 60 and which is managed in the state of being associated with the UE-R 15, is included in the message itself.

Furthermore, in a case where the ProSe capability information on the UE-R 15 is not included in the location update request message, the message is transmitted in the state where the information for identifying the ProSe Server 90 is not included in the message itself.

Furthermore, in the case where the information for identifying the ProSe Server 90 is not managed for the UE-R 15, the context response may be transmitted in the state where the information for identifying the ProSe Server 90 is not included in the context response itself.

The prose capability information may be the capability information indicating that the direct communication path to the neighboring UE can be established and may be the capability information indicating that the ProSe service can be enjoyed. Furthermore, the prose capability information may be the information indicating that the ProSe service is enjoyed and may be the information indicating that the direct communication path to the neighboring terminal is established.

Additionally, whether or not to include the information for identifying the ProSe Server 90 may be determined depending on the presence or absence of the application identification, the application user identification information, the prose code, or the like, which is included in the context request message.

For example, in the case where the context request message in which the application identification information, the application user identification, or the ProSe code is included is received, the message is transmitted in the state where the information for identifying the ProSe Server 90, which is retained by the MME-A 35 and which is managed in the state of being associated with the UE-R 15, is included in the message itself.

Furthermore, in the case where the application identification information, the application user identification information, or the ProSe code is not included in the context request message, the message is transmitted in the state where the information for identifying the ProSe Server 90 is not included in the message itself.

Furthermore, in the case where the information for identifying the ProSe Server 90 is not managed for the UE-R 15, the context response may be transmitted in the state where the information for identifying the ProSe Server 90 is not included in the context response itself.

In this manner, whether or not the UE-R 15 receives the ProSe service may be determined depending on the presence or absence of the application identification information, the application user identification information, or the ProSe code.

The HSS 60 may perform the transmission in the state where the information for identifying the ProSe Server 90 is included, based on either of the flag for requesting the information for identifying the ProSe Server 90, the capability information indicating that the ProSe Server can be enjoyed, and the information indicating that the direct communication path is established between the neighboring terminals. The HSS 60 may determine that the pieces of information described above are included in combination, such as when it is determined that the multiple pieces of information described above are included, and may perform the transmission in a state where the information for identifying the ProSe Server 90 is included. The MME-A 35 transmits the tracking area update acceptance message to the UE-R 15 (S1318). The tracking area update acceptance message may be transmitted based on the reception of the bearer update response message, and may be transmitted based on the reception of the location update response.

By transmitting the tracking area update acceptance message, the MME-A 35 may notify that the tracking area is updated, in response to the request for the update of the tracking area that is made by the UE-R 15.

The updated QoS information on the PDN connection that is established between the UE-R 15 and the PGW 50 may be transmitted in the state of being included in the message.

The updated QoS information on the PDN connection that is established between the UE-R 15 and the UE 10 may be transmitted in the state of being included in the message.

Additionally, the pieces of information relating to the radio bearers that are these communication paths may be included. For example, the pieces of information relating to the radio resource for the communication path, such as the frequency and the time information such as the transmission timing may be transmitted in the state of being included in the message. The MME-A 35 may newly perform the allocation of the radio resource, and the information relating to the newly-allocated radio resource may be notified in the state of being included in the message. The information relating to the radio resource may be acquired from the information that is included in the bearer update response message from the SGW 40, and the acquired information relating to the radio resource may be notified to the UE-R 15.

Additionally, the information for identifying the MME-A 35 may be transmitted in the state of being included in the tracking area update acceptance message. In this manner, by transmitting the message in the state where the MME-A 35 is included in the message itself, to the UE-R 15, the MME-A 35 may notify that the position management device is relocated (MME-Allocation).

The UE-R 15 may receive the tracking area update acceptance from the MME-A 35, and, based on the reception thereof, may transmit the tracking area update completion message to the MME-A 35. Subsequent to this, the UE-R 15 completes the tracking area update procedure that is accompanied by the relocation (MME-Allocation) of the position management device.

Additionally, based on the information that is included in the tracking area update acceptance, the UE-R 15 may update the information relating to the radio bearer. For example, the pieces of information relating to the radio resource for the communication path, such as the frequency and the time information such as the transmission timing may be updated. When it comes to the pieces of information relating to the radio resource, the information relating to the direct communication path between the UE-R 15 and the UE 10 may be updated, and the information relating to the PDN connection between the UE-R 15 itself and the PGW 50.

Additionally, the UE-R 15 may notify the UE 10 that the radio resource relating to the direct communication path is updated and may make a request for an update of the information relating to the radio resource that is retained by the UE 10. The information relating to the radio resource that is included in the tracking request acceptance may be notified in the state of being included in such a request.

With the above-described procedure, in the state of the idle mode, the UE-R 15 can perform the update of the tracking area that is accompanied by the relocation (MME-Allocation) of the position management device.

Additionally, in the above-described procedure, the update of the tracking area, as well as the relocation (MME-Allocation) of the position management device, can be performed without changing the ProSe Server that manages the direct communication service between the neighboring terminals using the direct communication path between the UE-R 15 and the UE 10. To realize this, when the UE-R 15 moves in the state of the idle mode, the MME-A 35, which is the position management device which manages the base station that is the destination, acquires the ProSe Server that is retained by the MME 30 before the UE-R 15 moves.

Furthermore, the UE-R 15, although in the idle mode in which the radio resource between the UE-R 15 itself and the base station, can maintain the communication that uses the direct communication path between the UE-R 15 itself and the UE 10, and performs the transmission and reception of data that use the direct communication path. When the UE-R 15 can transition to the idle mode, the radio resources of the entire communication system can be effectively used by releasing the radio resource between the UE-R 15 itself and the base station.

Furthermore, in the above-described procedure, following such a movement of the UE-R 15 in the idle mode, although the position management device is relocated, the MME-A 35 that is the position management device which manages the base station that is the destination can acquire the ProSe Server that is retained by the MME 30 before the UE-R 15 moves. Because of this, the ProSe Server 90 is not changed, and the UE-R 15 can maintain the establishment of the direct communication path for the neighboring terminal such as the UE 10, and the transmission and reception of data that use the direct communication path.

Furthermore, the UE-R 15 may transmit the request information for requesting the MME-A 35 to acquire the information for identifying the ProSe Server 90, in the state of being included in the tracking area update request.

Any request information with which the need for the MME-A 35 to acquire the information for identifying the ProSe Server 90 can be detected may be used and the request information may be the ProSe capability information on the UE-R 15. The prose capability information may be the capability information indicating that the direct communication path to the neighboring UE can be established and may be the capability information indicating that the ProSe service can be enjoyed. Furthermore, the prose capability information may be the information indicating that the ProSe service is enjoyed and may be the information indicating that the direct communication path to the neighboring terminal is established. Alternatively, the ProSe capability information may be the flag for requesting the ProSe Server 90 is acquired, or the like.

Additionally, the eNB 25 may receive the tracking area update request message in which the request information for requesting that the MME-A 35 should acquire the information for identifying the ProSe Server 90 is included, and may transmit the location update request message to the HSS 60.

Based on whether or not the request information for requesting that the MME-A 35 should acquire the information for identifying the ProSe Server 90 is included in the tracking area update request message that is received from the UE-R 15, the received request information may be transmitted to the HSS 60 in a state of being included in the location update request message, and the information for identifying the ProSe Server 90 may be requested.

Furthermore, based on the whether or not the request formation for requesting that the MME-A 35 should acquire the information for identifying the ProSe Server 90 is included in the received tracking area update request message, the MME-A 35 may include the flag for making a request to the HSS 60 for the information for identifying the ProSe Server 90 that provides the direct communication service between the neighboring terminals to the UE-R 15, in the location update request message.

For example, in the case where the request formation for requesting that the MME-A 35 should acquire the information for identifying the ProSe Server 90 is included in the received tracking area update request message, the MME-A 35 transmits the location update request message to the HSS 60, in a state where the flag for requesting the information for identifying the ProSe Server 90 that provides the direct communication service between the neighboring terminals to the UE-R 15 is included in the location update request message itself.

Furthermore, in the case where the request formation for requesting that the MME-A 35 should acquire the information for identifying the ProSe Server 90 is not included in the received tracking area update request message, the MME-A 35 transmits the location update request message to the HSS 60, in a state where the flag for requesting the information for identifying the ProSe Server 90 that provides the direct communication service between the neighboring terminals to the UE-R 15 is not included in the location update request message itself.

Accordingly, only when the communication terminal that can establish the direct communication path makes a request to the MME-A 35 for the update of the tracking area, the MME-A 35 can acquire the information for identifying the ProSe Server 90. In other words, in the case where the communication terminal in the related art that has the difficulty in performing the establishment of the direct communication path, or the communication terminal in which the function of performing the establishment of the direct communication path or the like is disabled makes the tracking area update request, the MME-A 35 ends up without acquiring the information for identifying the ProSe Server 90.

Furthermore, the transmission of the location update request by the MME-A 35 may be performed just after the tracking area update request message is received, may be performed based on reception of a context ACK message in a state where information that is included in a tracking area request information message is retained, and may be transmitted based on the reception of the bearer update response message.

Furthermore, in the procedure that is described in 1.3.5, in a case where, for example, for the reason that the MME 30 does not retain the information for identifying the ProSe Server 90, the context response is transmitted to the MME-A 35 in a state where the information for identifying the ProSe Server 90 is not included in the context response itself. In this case, because the information for identifying the ProSe Server 90 is not included in the context response message, by transmitting the location update request message, the MME-A 35 may make a request to the HSS 60 for the information for identifying the ProSe Server 90 and may acquire the information for identifying the ProSe Server 90. Furthermore, as described so far, the MME-A 35 may transmit the location update request message, based on the information that is included in the tracking area update request, and may transmit the location update request message based on the fact that the information on the ProSe Server 90 is not included in the context response. Additionally, the location update request message may be transmitted according to these conditions in combination.

According to the above-described procedure, the request for the information for identifying the ProSe Server 90 may be made to the HSS 60 with the location update request message, and the information for identifying the ProSe Server 90 may be acquired with a location registration response message that is transmitted by the HSS 60.

Furthermore, the MME-A 35 may receive the information for identifying the ProSe Server 90 from the MME 30, and may notify the ProSe Server 90 that the position management device which performs the position management of the UE-R 15 is updated.

The update procedure that is executed by the position management device is described referring to FIG. 14. The MME-A 35 transmits the context update request message to the ProSe Server 90 (S1402). The information for identifying the MME-A may be transmitted in the state of being included in the message, and an update of the position management device may be requested.

The transmission of the context request message by the MME-A 35 may be performed based on the reception of the location update response message from the HSS 60 (S1520), which is described above referring to FIG. 15.

The ProSe Server 90 may receive the context update request message and may update and retain the information for identifying the position management device, which is included in the message. For example, the ProSe Server 90 may retain the information for identifying the MME 30 as the position management device, in the state of being associated with the UE-R 15, and, based on the reception of the context request message, may update the information on the position management of the UE-R 15 from the MME 30 to the MME-A 35 for management.

Based on the reception of the context update request message, the ProSe Server 90 may transmit the context update response message to the MME-A 35 (S1404). Alternatively, based on the update of information that corresponds to the position management device for the UE-R 15, the context update response message may be transmitted to the MME-A 35.

In this manner, by transmitting the context update response message, the ProSe Server 90 may update the information that corresponds to the position management device for the UE-R 15 and may notify that the update is completed.

Furthermore, the ProSe Server 90 may include the information relating to the radio bearer that is the direct communication path, which is established by the UE-R 15 between the UE-R 15 itself and the UE 10. For example, the pieces of information relating to the radio resource for the communication path, such as the frequency and the time information such as the transmission timing may be transmitted in the state of being included in the message. The ProSe Server 90 may newly perform the allocation of the radio resource, and the information to the newly-allocated radio source may be notified in the state of being included in the message. The information relating to the radio resource that is already allocated to the direct communication path between the UE-R 15 and the UE 10 may be retained and the retained information may be read.

The MME-A 35 may receive the context update response, and based on the reception thereof, may transmit the resource reallocation request message to the eNB 25 (S1406). The information relating to the radio bearer that is the communication path may be included in the message. For example, the pieces of information relating to the radio resource for the communication path, such as the frequency and the time information such as the transmission timing may be transmitted in the state of being included in the message.

The information relating to the radio resource may be transmitted in the state of including the information that is notified by the ProSe Server 90. Alternatively, the MME-A 35 may newly perform the allocation of the radio resource, and the information relating to the radio resource may be notified in the state of being included in the message.

The eNB 25 may receive the resource reallocation request message and based on the reception thereof, may transmit the resource reallocation request message to the UE-R 15 (S1408). The information relating to the radio bearer that is the communication path may be included in the message. For example, the pieces of information relating to the radio resource for the communication path, such as the frequency and the time information such as the transmission timing may be transmitted in the state of being included in the message.

The information relating to the radio resource may be transmitted in the state of including the information that is notified by the MME-A 35. Alternatively, the eNB 25 may newly perform the allocation of the radio resource, and the information relating to the radio resource may be notified in the state of being included in the message.

The UE-R 15 may receive the resource reallocation request message and based on the reception thereof, may transmit the resource reallocation request message to the UE 10. The information relating to the radio bearer that is the communication path may be included in the message. For example, the pieces of information relating to the radio resource for the communication path, such as the frequency and the time information such as the transmission timing may be transmitted in the state of being included in the message.

The information relating to the radio resource may be transmitted in the state of including the information that is notified by the eNB 25. Alternatively, the UE-R 15 may newly perform the allocation of the radio resource, and the information relating to the radio resource may be notified in the state of being included in the message.

As described above, in the ProSe Server 90, the update of the information for identifying the position management device, which is associated with the UE-R 15 may be performed. Additionally, the reallocation of the radio resource for the direct communication path between the UE-R 15 and the UE 10 may be performed.

The embodiments and the multiple modification examples relating to the embodiments are described above, but each of the modification examples may be applied independently to the first embodiment, and two or more of the modification examples may be applied in combination. Furthermore, the embodiments according to the present invention are described above in detail referring to the drawings, but the specific configuration is not limited to the embodiments described above and a design and the like within a scope not deviating from the gist of the present invention fall within the scope of claims.

Furthermore, the UE-R 15 that has the relay function has so far has been described as executing the tracking area update procedure, but the UE 10 that has the relay function may initiatively execute the tracking area update procedure, by performing the same function as that of the UE-R 15 that has so far been described. At that time, each of the processing operations by UE-R 15, which have so far been described, may only be performed by the UE 10, the information for identifying the terminal device may be simply changed for each of the processing operations by the eNB 25, the MME-A 35, the MME 30 and the HSS 60, and the processing operations that have so far been described may be performed.

A program running on each of the apparatus and the device according to each embodiment is a program (a program that causes a computer to operate) that controls a CPU and the like in such a manner as to realize the functions according to the embodiments described above. Then, pieces of information that are handled in the apparatus and the device is temporarily stored in a temporary storage device (for example, a RAM) while being processed. Thereafter, the pieces of information are stored in various storage devices, that is, ROMs or HDDs, and if need arises, is read by the CPU in order to be modified or written.

Here, as a recording medium on which to store the program, among a semiconductor medium (for example, a ROM, a nonvolatile memory card, or the like), an optical recording medium or optical magnetic recording medium (for example, a Digital Versatile Disc (DVD), a Magneto Optical Disc (MO), a Mini Disc (MD), a Compact Disc (CD), a BD, or the like), a magnetic storage medium (for example, a magnetic tape, a flexible disk, or the like), and the like, any one may be used. Furthermore, in some cases, the functions according to the embodiments described above are realized by executing the loaded program, and in addition, the functions according to the present invention are realized by performing processing in conjunction with an operating system, other application programs, or the like, based on an instruction from the program.

Furthermore, in a case where the programs are distributed on the market, the programs, each of which is stored on a portable recording medium, can be distributed, or can be transferred to a server computer that is connected through a network such as the Internet. In this case, of course, a storage device of the server computer is also included in the present invention.

Furthermore, some or all portions of the apparatus and some or all portions of the device according to the embodiments, which are described above, may be realized as a Large Scale Integration (LSI) that is a typical integrated circuit. Each functional block of each of the apparatus and the device may be individually built into a chip, and some or all functional blocks may be integrated into a chip. Furthermore, a technique for the integrated circuit is not limited to the LSI, and an integrated circuit for the functional block may be realized as a dedicated circuit or a general-purpose processor. Furthermore, if with advances in a semiconductor technology, a circuit integration technology with which an LSI is replaced appears, of course, it is also possible to use an integrated circuit to which such a technology is applied.

### REFERENCE SIGNS LIST

1 MOBILE COMMUNICATION SYSTEM
5 IP MOBILE COMMUNICATION NETWORK
7 CORE NETWORK
9 LTE ACCESS NETWORK
10 UE
15 UE-R
20 eNB
30 MME
40 SGW
50 PGW
60 HSS
70 PCRF
80 PDN
90 ProSe Server

1. A communication control method for use in a position management device in a tracking area update procedure for updating a tracking area of a terminal device that transitions to an idle state where a radio resource is released, the method comprising:
a step of receiving a tracking area update request that is transmitted by the terminal device and that is transferred by a base station device;
a step of resolving an existing position management device with which the terminal device registers a tracking area, based on the tracking area update request;
a step of transmitting a context request to the existing position management device;
a step of receiving a context response that is a response to the context request and that is transmitted by the existing position management device;
a step of acquiring information for identifying a ProSe Server, which is included in the context response; and
a step of storing the information for identifying the ProSe Server and the terminal device in a state of being associated with each other.

2. The communication control method according to claim 1,
wherein identification information for requesting transmission of the information for identifying the ProSe Server is transmitted in a state of being included in the context request.

3. The communication control method according to claim 2,
wherein, in a case where capability information indicating that the terminal device is able to perform communication using a direct communication path between the terminal device itself and a neighboring terminal is included in the tracking area update request, the identification information for requesting the transmission of the information for identifying the ProSe Server is transmitted in a state of being included in the context request, and
wherein, in a case where the capability information is not included, the identification information for requesting the transmission of the information for identifying the ProSe Server is transmitted in a state of not being included in the context request.

4. A communication control method for use in a position management device in a tracking area update procedure for updating a tracking area of a terminal device that transitions to an idle state where a radio resource is released, the method comprising:
a step of receiving a tracking area update request that is transmitted by the terminal device and that is transferred by a base station device;
a step of transmitting a location update request that includes information for identifying the position management device and information for identifying the terminal device, to a subscriber information management device;
a step of receiving a location update response that is a response to the location update request and that is transmitted by the subscriber information management device;
a step of acquiring information for identifying a ProSe Server, which is included in the location update response; and
a step of storing the information for identifying the ProSe Server and the terminal device in a state of being associated with each other.

5. The communication control method according to claim 4,
wherein identification information for requesting transmission of the information for identifying the ProSe Server is transmitted in a state of being included in the location update request.

6. The communication control method according to claim 5,
wherein, in a case where capability information indicating that the terminal device is able to perform communication using a direct communication path between the terminal device itself and a neighboring terminal is included in the tracking area update request, the identification information for requesting the transmission of the information for identifying the ProSe Server is transmitted in a state of being included in the location update request, and
wherein, in a case where the capability information is not included, the identification information for requesting the transmission of the information for identifying the ProSe Server is transmitted in a state of not being included in the location update request.

7. The communication control method according to any one of claims 1 to 6, further comprising:
a step of transmitting a context update request that includes the information for identifying the position management device, and the information for identifying the terminal device, to the ProSe Server, based on the acquisition of the information for identifying the ProSe Server; and
a step of receiving a context update response that is a response to the context update request and that is transmitted by the ProSe Server.

8. A communication control method for use in a terminal device in a tracking area update procedure for updating a tracking area of the terminal device that transitions to an idle state where a radio resource is released, the method comprising:
a step of transmitting a tracking area update request that includes capability information indicating that the terminal device is able to perform communication using a direct communication path between the terminal device itself and a neighboring terminal, to a base station device; and
a step of receiving a tracking area update acceptance that is a response to the tracking area update request and that is transmitted by a position management device.

9. A communication control method for use in a base station device in a tracking area update procedure for updating a tracking area of a terminal device that transitions to an idle state where a radio resource is released, the method comprising:
a step of receiving a tracking area update request that is transmitted by the terminal device; and
a step of transmitting the tracking area update request that includes capability information indicating that the terminal device is able to perform communication using a direct communication path between the terminal device itself and a neighboring terminal, to a position management device, based on the reception of the tracking area update request.

10. A position management device in a communication system that is constituted to include a terminal device that transitions to an idle state where a radio resource is released, a base station device that is constituted to be in an access network, a position management device that is constituted to be in a core network, and a subscriber management device,
wherein a tracking area update request that is transmitted by the terminal device and that is transferred by the base station device is received,
wherein an existing position management device with which the terminal device registers a tracking area is resolved based on the tracking area update request,
wherein a context request is transmitted to the existing position management device,
wherein a context response that is a response to the context request and that is transmitted by the existing position management device is received,
wherein information for identifying a ProSe Server, which is included in the context response, is acquired, and
wherein the information for identifying the ProSe Server and the terminal device are stored in a state of being associated with each other.

11. The position management device according to claim 10,
wherein identification information for requesting transmission of the information for identifying the ProSe Server is transmitted in a state of being included in the context request.

12. The position management device according to claim 11,
wherein, in a case where capability information indicating that the terminal device is able to perform communication using a direct communication path between the terminal device itself and a neighboring terminal is included in the tracking area update request, the identification information for requesting the transmission of the information for identifying the ProSe Server is transmitted in a state of being included in the context request, and
wherein, in a case where the capability information is not included, the identification information for requesting the transmission of the information for identifying the ProSe Server is transmitted in a state of not being included in the context request.

13. A position management device in a communication system that is constituted to include a terminal device that transitions to an idle state where a radio resource is released, a base station device that is constituted to be in an access network, a position management device that is constituted to be in a core network, and a subscriber management device,
wherein a tracking area update request that is transmitted by the terminal device and that is transferred by the base station device is received,
wherein a location update request that includes information for identifying the position management device and information for identifying the terminal device is transmitted to a subscriber information management device,
wherein a location update response that is a response to the location update request and that is transmitted by the subscriber information management device is received,
wherein information for identifying a ProSe Server, which is included in the location update response, is acquired, and
wherein the information for identifying the ProSe Server and the terminal device are stored in a state of being associated with each other.

14. The position management device according to claim 13,
wherein identification information for requesting transmission of the information for identifying the ProSe Server is transmitted in a state of being included in the location update request.

15. The position management device according to claim 14,
wherein, in a case where capability information indicating that the terminal device is able to perform communication using a direct communication path between the terminal device itself and a neighboring terminal is included in the tracking area update request, the identification information for requesting the transmission of the information for identifying the ProSe Server is transmitted in a state of being included in the location update request, and
wherein, in a case where the capability information is not included, the identification information for requesting the transmission of the information for identifying the ProSe Server is transmitted in a state of not being included in the location update request.

16. The position management device according to any one of claims 10 to 15,
wherein a context update request that includes the information for identifying the position management device, and the information for identifying the terminal device, is transmitted to the ProSe Server, based on the acquisition of the information for identifying the ProSe Server, and
wherein a context update response that is a response to the context update request and that is transmitted by the ProSe Server is received.

17. A terminal device that transitions to an idle state where a radio resource is released,
wherein a tracking area update request that includes capability information indicating that the terminal device is able to perform communication using a direct communication path between the terminal device itself and a neighboring terminal, is transmitted to a base station device, and
wherein a tracking area update acceptance that is a response to the tracking area update request and that is transmitted by a position management device is received.

18. A base station device in a communication system that is constituted to include a terminal device that transitions to an idle state where a radio resource is released, a base station device that is constituted to be in an access network, a position management device that is constituted to be in a core network, and a subscriber management device,
wherein a tracking area update request that is transmitted by the terminal device is received, and
wherein the tracking area update request that includes capability information indicating that the terminal device is able to perform communication using a direct communication path between the terminal device itself and a neighboring terminal, is transmitted to the position management device, based on the reception of the tracking area update request.

19. A communication system that is constituted to include a terminal device that transitions to an idle state where a radio resource is released, a base station device that is constituted to be in an access network, a position management device that is constituted to be in a core network, and a subscriber management device,
wherein the terminal device transmits a tracking area update request to the base station device,
wherein the base station device transmits the tracking area update request to the position management device, based on the reception of the tracking area update request,
wherein the position management device receives the tracking area update request that is transmitted by the terminal device and that is transferred by the base station device,
wherein an existing position management device with which the terminal device registers a tracking area is resolved based on the tracking area update request,
wherein a context request is transmitted to the existing position management device,
wherein a context response that is a response to the context request and that is transmitted by the existing position management device is received,
wherein information for identifying a ProSe Server, which is included in the context response, is acquired,
wherein the information for identifying the ProSe Server and the terminal device are stored in a state of being associated with each other, and
wherein a tracking area update acceptance is transmitted to the terminal device.

20. The communication system according to claim 19,
wherein, in a case where capability information indicating that the terminal device is able to perform communication using a direct communication path between the terminal device itself and a neighboring terminal is included in the tracking area update request, the position management device transmits the identification information for requesting the transmission of the information for identifying the ProSe Server, in a state of being included in the context request, and
wherein, in a case where the capability information is not included, the position management device transmits the identification information for requesting the transmission of the information for identifying the ProSe Server, in a state of not being included in the context request.

21. The communication system according to claim 19 or 20,
wherein a terminal device transmits a tracking area update request that includes capability information indicating that the terminal device is able to perform communication using a direct communication path between the terminal device itself and a neighboring terminal, to the base station device, and
wherein the terminal device receives a tracking area update acceptance that is a response to the tracking area update request and that is transmitted by the position management device.
